(19) United States
(12) Patent Application Publication
(10) Pub. No.: US 2026/0342452 A1
(43) Pub. Date: Oct. 29, 2026

(54) SYSTEMS AND METHODS FOR DISTRIBUTING ENTANGLEMENT

(71) Applicant: PHOTONIC INC., Coquitlam (CA)

(72) Inventors: Thomas JENNEWEIN, Waterloo (CA); Evan MEYER-SCOTT, Edmonton (CA)

(21) Appl. No.: 19/487,407

(22) PCT Filed: Apr. 3, 2024
(86) PCT No.: PCT/CA2024/050430

§ 371 Date: Nov. 24, 2025

Related U.S. Application Data
(60) Provisional application No. 63/509,457, filed on Jun. 21, 2023.

(51) Int. Cl. H04B 10/70; H04B 10/11

(52) U.S. Cl. CPC H04B 10/70; H04B 10/11

(57) ABSTRACT

Quantum entanglement may be distributed at a high rate over an optical link by sequential emission of spin-entangled optical photon states from different matter based quantum systems into the optical link and execution of a heralded entanglement protocol using the emitted photon states. The quantum systems can be provided by luminescent centers such as T centres, for example. Quantum states of the quantum systems may be transferred to other quantum systems after emission of the photon states. Entanglement swapping may be performed to extend the entanglement to be between quantum systems. The technology has example application in cases where optical fibre links are shared between many nodes and/or where it is desired to extend entanglement to an orbiting satellite, and is particularly useful when optical links are not simultaneously available.

### CROSS-REFERENCE TO RELATED APPLICATIONS

This application claims priority from U.S. application No. 63/509,457 filed 21 Jun. 2023 and entitled SYSTEMS AND METHODS FOR DISTRIBUTING ENTANGLEMENT which is hereby incorporated herein by reference for all purposes. For purposes of the United States of America, this application claims the benefit under 35 U.S.C. § 119 of U.S. application No. 63/509,457 filed 21 Jun. 2023 and entitled SYSTEMS AND METHODS FOR DISTRIBUTING ENTANGLEMENT which is hereby incorporated herein by reference for all purposes.

### FIELD

The present technology relates to creating quantum entanglement between spaced apart quantum systems. In some embodiments the quantum systems are spaced apart by long distances. The present technology has example application to quantum communication.

### BACKGROUND

Two or more quantum systems are said to be “entangled” when “the quantum state of any one of the entangled quantum systems cannot be described independently of the state of the other one(s) of the entangled quantum systems. Quantum entanglement has applications that include transferring a quantum state from one quantum system to another over an arbitrary distance using a quantum teleportation protocols and applying two qubit quantum gates to quantum systems that are separated by arbitrary distances using a protocol for teleporting controlled gates. Entangled quantum systems may, for example, be applied to transfer and manipulate quantum information in quantum informatics networks.

Providing entangled quantum systems at specified spaced apart locations can be difficult especially where the distance is large. Protocols to provide two quantum systems that are entangled can involve one or more of:
performing a measurement (e.g. a Bell state measurement or “BSM”) which projects the combined state of the two quantum systems onto an entangled state;
causing certain interactions between the quantum systems either directly or by way of intermediate particles; and
causing a quantum interaction that results in creation of a pair of entangled quantum systems.

In general, these protocols struggle to provide entangled particles that are separated by larger distances. An additional problem is that quantum systems can never be completely isolated. Random interactions between a quantum system that is initially in desired state and its surroundings can cause the quantum state to decohere over time.

Photons may be used to mediate entanglement of quantum systems. For example, an entanglement protocol using photons is described in Sean D. Barrett, Pieter Kok Efficient high-fidelity quantum computation using matter qubits and linear optics, Phys. Rev. A 71, 060310(R) (2005) which is hereby incorporated herein by reference for all purposes. The photons may be carried in optical fibers. However, due to interactions with the environment, optical fibers are a noisy quantum channel. The losses experienced during propagation of photons in optical fibers limits the distance over which entanglement can practically be distributed by way of optical fibers to at most a few hundred kilometers.

Quantum repeaters may be used to extend the distance over which entanglement can be distributed. A quantum repeater typically includes quantum memories which are configured for entanglement swapping operations. Entanglement swapping is a process according to which entanglement of two or more pairs of quantum systems is reduced to entanglement of a new pair of the quantum systems by a process that consumes entanglement of the original entangled pairs.

For example, consider the case where stations A, B and C respectively host quantum systems A1, B1 and B2, and C2 and it is desired to provide entanglement of quantum systems A1 and C2. Stations A and B are coupled by an optical fiber and stations B and C are coupled by an optical fiber. The goal of entangling quantum systems A1 and C1 could be achieved by entangling quantum systems A1 and B1 to yield a first entangled pair of quantum systems and entangling quantum systems B2 and C2 to yield a second entangled pair of quantum systems. The entanglement can then be swapped to be between quantum systems A1 and C2 by performing a Bell state measurement between quantum systems B1 and B2 which consumes the entanglement of the first and second pairs and creates entanglement of the new pair A1 and C2. It may be the case that stations A and C are far enough apart that it would not be practical to create entanglement of quantum systems A1 and C2 directly. In this example, the first and second pairs of entangled quantum systems can be considered to form an entanglement swapping chain which can be used to generate entanglement of quantum systems A1 and C2. Longer entanglement swapping chains are also possible. For example, an entanglement swapping chain made up of three pairs of entangled quantum systems A1-A2, B1-B2, and C1-C2 may be used to generate entanglement of quantum systems A1 and C2 by performing a BSM between quantum systems A2 and B1 and a BSM between quantum systems B2 and C1.

Quantum repeaters may be provided as intermediate nodes between two end points. Ideally, entanglement of quantum systems at the endpoints could be provided, no matter how far apart the endpoints are, by providing enough quantum repeaters and performing enough steps of entanglement swapping. While experimental demonstration of short-range quantum communications without quantum repeaters has been effective, long range repeater networks require practical fault-tolerant quantum error correction methods, which are currently unavailable. Another problem is that quantum repeaters, as currently envisioned would include both low-temperature quantum devices and higher power consumption devices together with active controls which would be required to perform reliably in hostile environments.

Satellites have been proposed as a platform for global-scale quantum communication. Photons can travel over longer distances with proportionally less loss in space outside of the earth's atmosphere than in optical fibers or in free-space transmission within the atmosphere. Several proposals for satellite-based quantum networks have been made.

A practical large area quantum communication network may include satellites which may be applied to distribute quantum entanglement over large distances as well as terrestrial systems, including optical fiber and free space channels, which interface to the satellites and provide connectivity to endpoints of the quantum communication network.

### SUMMARY

A general problem that the inventors have recognized is that optical links which may be used to distribute quantum entanglement may not be available when needed. Individual optical links may have brief periods of availability followed by periods when they are not available. For example, an optical link to a satellite may be available only when the satellite is at a certain orbital location and atmospheric conditions are suitable. As another example, an optical link may serve a variety of users and may be available to any particular user only at specified times.

Because at least some optical links that may be used to distribute entanglement in a quantum communication network may not be continuously available, optical links to quantum systems that are to be entangled may not be available simultaneously.

There is a need for practical methods and systems for distributing quantum entanglement in quantum communication networks.

The present invention has a number of aspects. These include, without limitation: methods for distributing quantum entanglement and systems for distributing quantum entanglement. In some embodiments the methods and apparatus are used to distribute quantum entanglement and/or quantum keys by way of a moving station such as an earth orbiting satellite, a land vehicle, an airplane, a balloon, etc.

One example aspect of the invention provides a method for distributing quantum entanglement. At a station, when a first optical link between the station and a first node is available, a first communication quantum system of the station is caused to emit a first photon state that is entangled with a first quantum state of the first communication quantum system into the first optical link. When a second optical link between the station and a second node is available a second communication quantum system of the station is caused to emit a second photon state that is entangled with a second quantum state of the second communication quantum system into the second optical link. First and second information is received at the station. The first information indicating that entanglement of the first quantum state with a first node quantum system of the first node was generated using the first photon state. The second information indicating that entanglement of the second quantum system with a second node quantum system of the second node was generated using the second photon state. In the method, quantum states of the first node quantum system and the second node quantum system are caused to be entangled by performing a measurement on the first and second quantum states.

In some embodiments the first and second communication quantum systems of the station each comprises an electron spin and the first photon state and the second photon state each comprises a spin-entangled photon state. In some embodiments, after emission of the first photon state, transferring the first quantum state of the first communication quantum system to a first memory quantum system of the station and/or after emission of the second photon state, transferring the second quantum state of the second communication quantum system to a second memory quantum system of the station. In some embodiments the first memory quantum system has a longer coherence time than the first communication quantum system and/or the second memory quantum system has a longer coherence time than the second communication quantum system. In some embodiments the first memory quantum system comprises a nuclear spin and/or the second memory quantum system comprises a nuclear spin.

In some embodiments the station comprises a plurality of T centres and each of the first and second communication quantum systems comprises an electron spin of one of the plurality of T centres. In some embodiments the first memory quantum system comprises a nuclear spin of one of the plurality of T centres and/or the second memory quantum system comprises a nuclear spin of one of the T centres.

In some embodiments the measurement comprises a Bell state measurement (BSM).

In some embodiments the first and second communication quantum systems comprise electron spins and the first and second photon states comprise spin-entangled photons.

In some embodiments one or more of the station, the first node and the second node is moving relative to the earth. In some embodiments the station is carried by an earth orbiting satellite. In some embodiments the satellite is orbiting in an orbit that is not geostationary. In some embodiments, one or more of the first node and the second node is carried by an earth-orbiting satellite.

In some embodiments one or both of the first and second optical links comprises a free space optical link.

In some embodiments the first communication quantum system is one of a plurality of first communication quantum systems of the station and the method comprises: sequentially causing each of the first communication systems to emit a respective first photon state into the first optical link. n some embodiments the respective first photon states are emitted at a rate of at least one of the respective photon states per 100 microseconds. In some embodiments, after each of the first communication quantum systems has been caused to emit the respective photon state, a respective first quantum state of the first communication quantum system is transferred to a respective one of a plurality of memory quantum systems of the station.

In some embodiments the second communication quantum system is one of a plurality of second communication quantum systems of the station and the method comprises sequentially causing each of the second communication systems to emit a respective second photon state into the second optical link.

In some embodiments the first information indicates, for each of the respective first photon states, whether or not entanglement of the respective first quantum state with a first node quantum system of the first node was generated using the respective photon state; and the second information indicates, for each of the respective second photon states, whether or not entanglement of the respective second quantum state with a second node quantum system of the second node was generated using the respective second photon state.

In some embodiments, the measurement is one of a plurality of measurements and the method comprises using the first and second information to identify plural pairs of the quantum systems of the station wherein each of the pairs includes one quantum system of the station that is entangled to a corresponding quantum system of the first node and one quantum system of the station that is entangled with a corresponding quantum system of the second node. The method may perform one of the plurality of measurements on each of the plurality of pairs of quantum systems of the station.

In some embodiments the first communication quantum system is one of a plurality of first communication quantum systems of the station; and the second quantum system is one of a plurality of second communication quantum systems of the station. In such embodiments the method may comprise emitting a sequence of the first photon states and a sequence of second photon states. The first information may indicate whether or not each of the first photon states in the sequence of first photon states resulted in entanglement of a corresponding one of the first quantum states with a quantum state of corresponding one of a plurality of first node quantum systems of the first node. The second information may indicate whether or not each of the second photon states in the sequence of second photon states resulted in entanglement of a corresponding one of the second quantum states with a quantum state of corresponding one of a plurality of second node quantum systems of the second node. While the first optical link is available the first communication quantum systems may be controlled to emit a sequence of first photon states into the first optical link, each of the first photon states being entangled with a respective first quantum state of the respective first communication quantum system that emitted the respective one of the first photon states. After emitting each of the first photon states the respective first quantum state may be transferred to a corresponding one of a plurality of first memory quantum systems of the station. While the second optical link is available the second communication quantum systems may be controlled to emit a sequence of second photon states into the first optical link, each of the second photon states being entangled with a respective second quantum state of the respective second communication quantum system that emitted the respective one of the second photon states. Plural entangled pairs, each of the plural entangled pairs comprising one of the first node quantum systems and one of the second node quantum systems, may be created by performing Bell state measurements at the station between one of the first quantum states and one of the second quantum states.

In some embodiments the first and second optical links are not concurrently available.

In some embodiments the method comprises monitoring the first optical link to determine when the first optical link is available and causing the first communication quantum system to emit the first photon state into the first optical link in response to determining that the first optical link is available.

Another example aspect of the invention provides a station operable to distribute quantum entanglement. The station comprises a plurality of quantum systems. The plurality of quantum systems comprises a plurality of first communication quantum systems operative to emit first photon states into a first optical link; and a plurality of second communication quantum systems operative to emit second first photon states into a second optical link. The station includes at least one measurement system comprising at least one Bell state analyzer (BSA). The measurement system is operable to perform Bell state measurements (BSMs) between pairs of the quantum systems of the station. A controller is configured to: when the first optical link between the station and the first node is available, cause a first one of the communication quantum systems of the station to emit a first photon state that is entangled with a first quantum state of the first one of the communication quantum systems into the first optical link; when a second optical link between the station and a second node is available cause a second one of the communication quantum systems of the station to emit a second photon state that is entangled with a second quantum state of the second communication quantum system into the second optical link and cause quantum states of the first node quantum system and the second node quantum system to be entangled by performing a measurement on the first and second quantum states using the measurement system. The controller may be configured to receive first and second information where the first information indicates that entanglement of the first quantum state with a first node quantum system of the first node was generated using the first photon state and the second information indicates that entanglement of the second quantum system with a second node quantum system of the second node was generated using the second photon state.

In some embodiments, the first and second communication quantum systems of the station each comprises an electron spin and the first photon state and the second photon state each comprises a spin-entangled photon state. In some embodiments, the station comprises a plurality of memory quantum systems and the controller is configured to: transfer the first quantum state from the first one of the communication quantum systems to a first one of the memory quantum systems; and/or transfer the second quantum state from the first one of the second communication quantum systems to a second one of the memory quantum systems; prior to performing the measurement. In some embodiments, the first one of the memory quantum systems has a longer coherence time than the first communication quantum system; and/or the second memory quantum system has a longer coherence time than the second communication quantum system. In some embodiments, the first memory quantum system comprises a nuclear spin; and/or the second memory quantum system comprises a nuclear spin.

In some embodiments, the station comprises a plurality of T centres and each of the first and second communication quantum systems comprises an electron spin of one of the plurality of T centres. In some embodiments, the first memory quantum system comprises a nuclear spin of one of the plurality of T centres and/or the second memory quantum system comprises a nuclear spin of one of the T centres.

In some embodiments, the station is movable relative to the earth while operating. In some embodiments, the station comprises a satellite. In some embodiments, the station is carried by an earth orbiting satellite on an orbit that is non-geostationary.

In some embodiments, the first and second optical links comprise free space optical links.

In some embodiments, the controller is configured to: cause a plurality of the first communication quantum systems to each emit a respective first photon state into the first optical link sequentially; and/or cause a plurality of the second communication quantum systems to each emit a respective second photon state into the second optical link sequentially.

In some embodiments, the station is operative to: emit the respective first photon states sequentially into the first optical link at a rate of at least one of the respective first photon states per 100 microseconds; and/or emit the respective second photon states sequentially into the second optical link at a rate of at least one of the respective second photon states per 100 microseconds.

In some embodiments, the controller is configured to, after each of the plurality of the first communication quantum systems has been caused to emit the respective first photon state, transfer a respective first quantum state of the respective first communication quantum system to a respective one of a plurality of memory quantum systems of the station; and/or after each of the plurality of the second communication quantum systems has been caused to emit the respective second photon state, transfer a respective second quantum state of the respective second communication quantum system to a respective one of the plurality of memory quantum systems of the station.

In some embodiments, the first information indicates, for each of the respective first photon states, whether or not entanglement of the respective first quantum state with a first node quantum system of the first node was generated using the respective first photon state; and the second information indicates, for each of the respective second photon states, whether or not entanglement of the respective second quantum state with a second node quantum system of the second node was generated using the respective second photon state.

In some embodiments, the controller is configured to use the first and second information to identify plural pairs of the quantum systems of the station wherein each of the pairs includes one quantum system of the station that is entangled to a corresponding quantum system of the first node and one quantum system of the station that is entangled with a corresponding quantum system of the second node; and perform a BSM on each of the plurality of pairs of quantum systems.

In some embodiments, the first communication quantum system is one of a plurality of first communication quantum systems of the station; the second quantum system is one of a plurality of second communication quantum systems of the station; and the controller is configured to: cause a sequence of the first photon states to be emitted into the first optical link while the first optical link is available, each of the first photon states being entangled with a respective first quantum state of the respective first communication quantum system that emitted the respective one of the first photon states; and cause a sequence of second photon states to be emitted into the second optical link while the second optical link is available each of the second photon states being entangled with a respective second quantum state of the respective second communication quantum system that emitted the respective one of the second photon states. After each of the first photon states is emitted the controller may transfer the respective first quantum state to a corresponding one of a plurality of first memory quantum systems of the station. After each of the second photon states is emitted the controller may transfer the respective second quantum state to a corresponding one of a plurality of second memory quantum systems of the station. The controller may create plural entangled pairs, each of the plural entangled pairs comprising one of the first node quantum systems and one of the second node quantum systems, by performing BSMs at the station between one of the first quantum states and one of the second quantum states. In some embodiments the first information indicates whether or not each of the first photon states in the sequence of first photon states resulted in entanglement of a corresponding one of the first quantum states with a quantum state of corresponding one of a plurality of first node quantum systems of the first node and the second information indicates whether or not each of the second photon states in the sequence of second photon states resulted in entanglement of a corresponding one of the second quantum states with a quantum state of corresponding one of a plurality of second node quantum systems of the second node.

In some embodiments, the controller is configured to monitor the first optical link to determine when the first optical link is available and cause the first communication quantum system to emit the first photon state into the first optical link in response to determining that the first optical link is available.

In some embodiments, the first and second optical links are free space optical links.

Another aspect of the invention provides an entanglement distribution system comprising a station as described herein in combination with the first and second nodes.

Another aspect of the invention provides apparatus having any new and inventive feature, combination of features, or sub-combination of features as described herein.

Another aspect of the invention provides methods having any new and inventive steps, acts, combination of steps and/or acts or sub-combination of steps and/or acts as described herein.

Further aspects and example embodiments are illustrated in the accompanying drawings and/or described in the following description.

It is emphasized that the invention relates to all combinations of the above features, even if these are recited in different claims, illustrated in different figures, described in different paragraphs, described in different sections of the disclosure, and/or described with reference to different example embodiments.

### BRIEF DESCRIPTION OF THE DRAWINGS

The accompanying drawings illustrate non-limiting example embodiments of the invention.

FIG. 1 is a schematic diagram showing components of an example system that may be operated for distributing quantum entanglement.

FIG. 2 is a schematic diagram showing components of another example system that may be operated for distributing quantum entanglement.

FIGS. 2A and 2B are flow charts that illustrate a method according to an example embodiment.

FIG. 3 is an isometric view of a model of a T centre.

FIG. 3A is a simplified energy level diagram for a T centre.

FIG. 4 is a schematic diagram showing components of another example system that may be operated for distributing quantum entanglement.

FIGS. 4A, 4B and 4C are flowcharts that illustrate a method according to another example embodiment.

FIG. 5 is a schematic diagram illustrating a system according to an example embodiment that includes an orbiting satellite.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

Aspects of the present technology provide systems and methods for distributing entanglement. In some embodiments, establishing entanglement of quantum systems to be used to facilitate communication between communicating parties may be performed asynchronously.

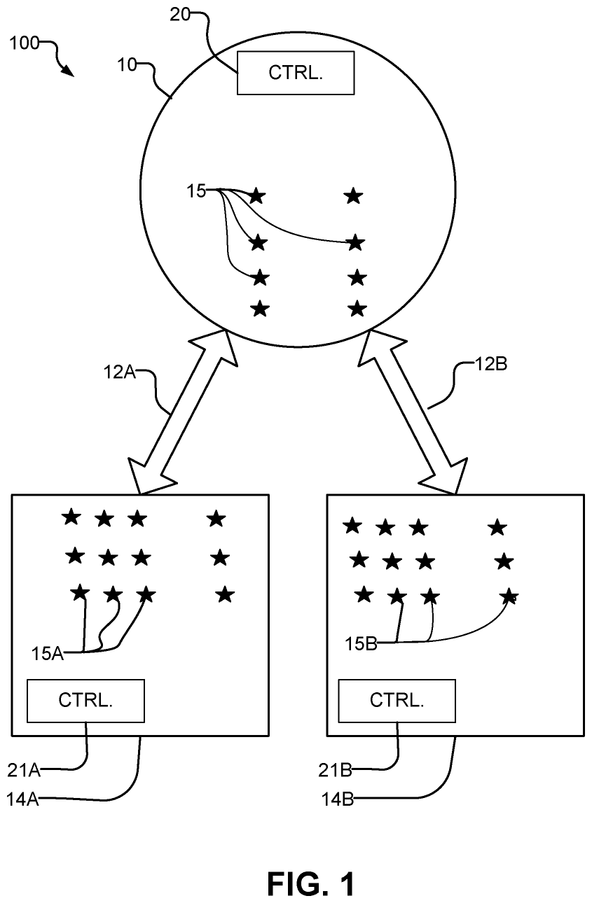

FIG. 1 is a block diagram showing an example system 100 for distributing entanglement according to an example embodiment of the technology. System 100 includes a station 10 that is connected by optical links 12A and 12B (generally and collectively optical links 12) to nodes 14A and 14B (generally or collectively nodes 14).

In some embodiments optical links 12A and 12B share some optical components. For example, in cases where optical links 12A and 12B are not used simultaneously, station 10 may have one optical structure (e.g. a telescope or optical port) that sometimes carries photons associated with optical link 12A and sometimes carries photons associated with optical link 12B. For example, where station 10 comprises an orbiting satellite, a telescope carried by the satellite may deliver photons to a node 14A when the satellite is passing over node 14A and the same telescope may be used to deliver photons to a node 14B when the satellite is passing over node 14B.

In some embodiments, photons associated with optical link 12A are distinguishable from photons associated with optical link 12B (e.g. the photons have different frequencies or polarizations) and station 10, node 14A and/or node 14B receives photons associated with optical links 12A and 12B at the same optical port before separating the photons (e.g. with suitable filters).

The elements shown in FIG. 1 may be part of a larger network. System 100 may include additional nodes 14 and/or additional stations 10 that are interconnected by additional optical links 12 in any suitable topology.

Optical links 12 are each capable of carrying photons between their endpoints. Ideally every optical link 12 would successfully transmit every photon received at one endpoint to the other endpoint of the optical link. In practice, optical links 12 are not ideal. A certain proportion of photons received at one endpoint will be lost and will not be transmitted to the other endpoint of the optical link 12.

Each node 14 and each station 10 includes a number of quantum systems 15. Each of quantum systems 15 has a quantum state. Quantum information may be stored in the quantum states of quantum systems 15. The quantum systems 15, for example, have two or more basis states. In general, the quantum state of the quantum system 15 may be represented by:

$${\vert ψ 〉 = {\sum }_{i = 1}^{Q} {α}_{i} \vert φ 〉}_{i} \qquad ( 1 )$$

where: |ψ [symbol] is the quantum state, Q is the number of basis states, αᵢ are complex coefficients, and |φ [symbol] ᵢ are the basis states. Importantly the quantum state |ψ [symbol] may be a superposition (linear combination) of the basis functions |φ [symbol] ᵢ.

In many applications quantum informatics uses two basis states of a quantum system to store quantum information. In such cases the quantum system may be referred to as a qubit. The quantum state of a qubit may be represented by a point on the Bloch sphere.

A qubit can be provided by a two-level quantum system such as an electron spin, a nuclear spin, or a photon. An example of a physical system that may be used as a qubit is a particle that has intrinsic spin of ½ (e.g. an electron, a hole or some nuclear spins). In such particles the basis states can be “spin up”, represented by |↑ [symbol] and “spin down”, represented by |↓ [symbol] and the quantum state can be an arbitrary superposition of the basis states given by:

|ψ [symbol] =∝₁|↓ [symbol] +∝₂|↑ [symbol] (2)

System 100 may be controlled by a control system that, in the illustrated embodiment comprises controllers 20, 21A and 21B, to generate entanglement between a quantum system of node 12A and a quantum system of node 12B. This may be done, for example, by steps that include: generating entanglement between a quantum system 15A of node 14A and a first quantum system 15 of station 10 and also generating entanglement between quantum system 15B of node 14B and a second quantum system of station 10 and subsequently swapping the entanglement to be between quantum systems 15A and 15B by performing an operation at station 10. The operation may, for example, comprise performing a BSM (“Bell state measurement”) between the first and second quantum systems of station 10. Unless otherwise indicated, the terms BSM and “Bell State Measurement” as used herein means a projective measurement onto any maximally entangled basis of Hilbert space for two qubits. One example of such a basis is the set of four Bell states. In some embodiments a BSM is a measurement that projects onto one of the four Bell states.

A complication is that optical links 12A and/or 12B may not be continuously available. Consider, for example, the case where station 10 is carried by a satellite orbiting the earth, nodes 14A and 14B are ground stations, and optical links 12A and 12B comprise free space links. In this case, each of optical links 12A and 12B may be available only when the satellite is in a certain part of its orbit and only when atmospheric conditions between the corresponding node 14 and station 10 permit transmission of photon states. In at least some cases optical links 12A and 12B may not be simultaneously available. The periods during which an optical link 12 is available may be relatively short.

Other reasons why a link 12 may be unavailable at certain times include cases such as: the optical link is dedicated to other purposes at certain times; one endpoint of the optical link is moving relative to the other endpoint (e.g. is carried by a train, balloon, unmanned aerial vehicle, airplane, marine vessel, on- or off-road vehicle etc.); the optical link is being serviced, broken or offline; and so on.

Another complication, which is mentioned above, is that optical links 12 can, in general be lossy. A photon transmitted to an optical link 12 will be received at the other end of the optical link 12 with a probability p which is less than one (sometimes significantly less than one).

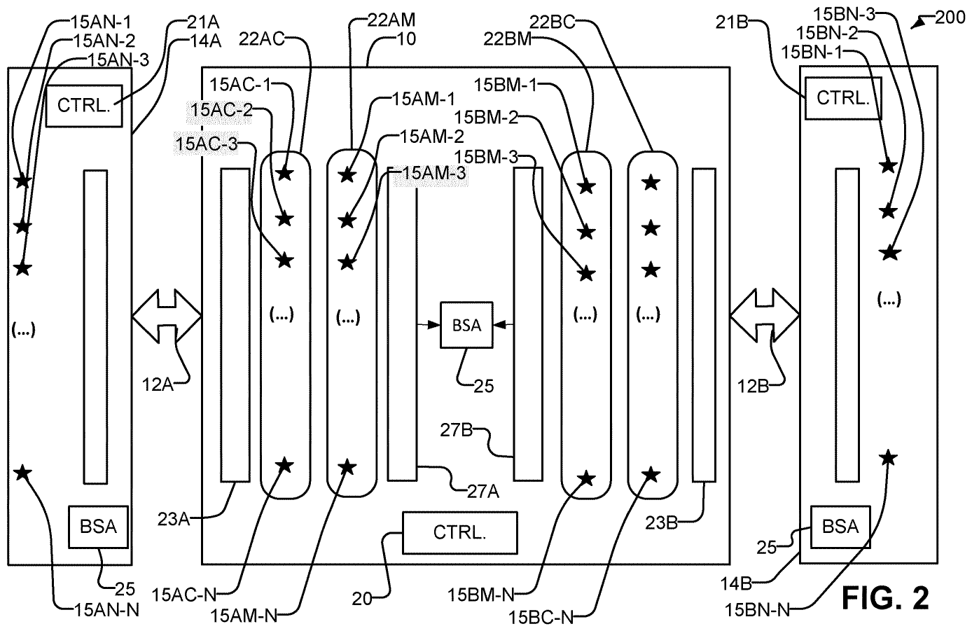

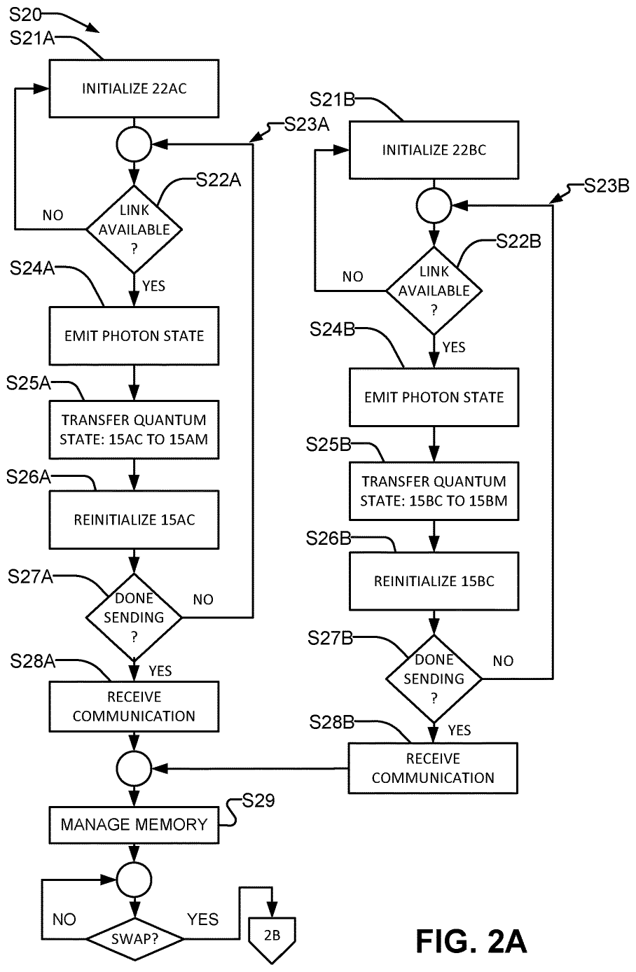

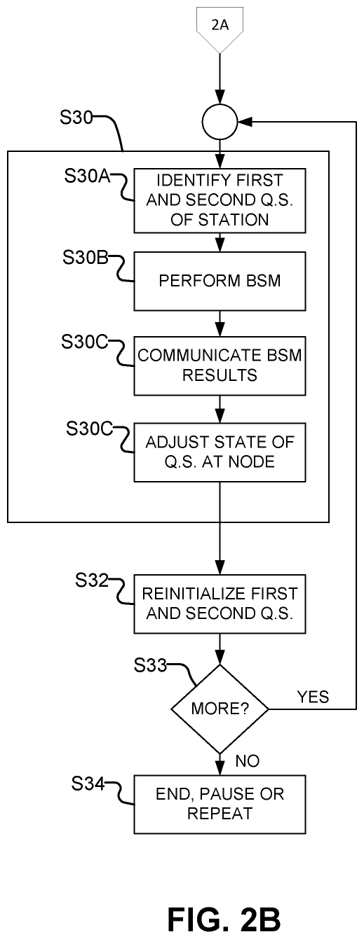

These issues may be addressed by providing in station 10 a plurality of quantum systems 15 that are controlled by a control system 20 as illustrated, for example by system 200 which is shown schematically in FIG. 2. At least some of quantum systems 15 are controllable to emit photon states into optical link 12A. At least some of quantum systems 15 are controllable to emit photon states into optical link 12B. Each of the photon states is entangled with the quantum state of the quantum system 15 from which the photon state was emitted.

For example, an optical switch or optical multiplexer 23A may be configurable or operable to direct photons from any of a first group 22AC of quantum systems 15 (labelled 15AC-1 to 15AC-N) into optical link 12A. An optical switch or multiplexer 23B may be configurable or operable to direct photons from any of a second group 22BC of quantum systems 15 (labelled 15BC-1 to 15BC-N) into optical link 12B. The quantum systems of groups 22AC and 22BC may be located close to optical links 12A and 12B respectively. The optical coupling of the quantum systems of groups 22AC and 22BC to optical links 12A and 12B may be designed to minimize photon loss.

Controller 20 may be configured to initialize the quantum systems 15 of group 22AC or 22BC to be ready to emit photon states when the respective optical link 12A or 12B becomes available.

Availability of any particular optical link 12 may be determined in various ways including: detecting light that has been sent in either direction through the optical link 12; and/or using a schedule that indicates periods in which the optical link 12 is available and/or not available. For example, quantum or classical optical signals may be delivered through the optical link 12 and detected upon exiting the optical link 12. Quantum signals (e.g. single photons) are advantageous as they are very weak and do not interfere with any classical communication that may be carried by the optical link 12. A quantum signal may be continuously delivered into one endpoint of the optical link 12. Detection of the quantum signal at the other end of the optical link 12 indicates availability of the optical link 12. System 10 and/or nodes 14 may comprise lookup tables or other data structures that store schedule information indicating times when one or more optical links 12 should be available.

The following description of a method that delivers photon states from quantum systems 15 of group 22AC into optical link 12A may be applied mutatis mutandis to deliver photon states from quantum systems 15 of group 22BC into optical link 12B.

FIG. 2A is a flowchart that shows an example method S20 that may be used for communicating quantum information. Method S20 may be coordinated by controller 20.

In step S21A method S20 initializes quantum systems of group 22AC. In some embodiments, step S21A also initializes the quantum systems of group 22AM. In some embodiments where it is known in advance when optical link 12A will become available, step S21A is timed so that the initialization of some or all of the quantum systems of groups 22AC and 22AM is complete by the time optical link 12A becomes available. In some embodiments the quantum systems of group 22AC and 22AM are initialized periodically and frequently enough so that they remain in an initialized state when optical link 12A becomes available.

Step S22A monitors to determine when optical link 12A becomes available. If optical link 12A is not available then step S22A waits or returns to step S21A. As soon as optical link 12A becomes available method S20 may cause the quantum systems 15 of group 22AC to emit photon states into optical link 12A in a sequence.

Step S22A is not mandatory. In some embodiments it is assumed that an optical link (here optical link 12A) is available. Other mechanisms (e.g. step S29 as discussed below) may detect whether the assumption that the optical link is available is incorrect. Any desired corrective action may then be taken.

Without loss of generality, the sequence in which quantum systems 15 of group 22AC are caused to emit photons may start with quantum system 15AC-1 and proceed through quantum systems 15AC-2, 15AC-3 etc., until a desired number of photon states has been transmitted (or optical link 12A is determined to no longer be available). If the sequence reaches quantum system 15AC-N the sequence may continue with causing quantum system 15AC-1 to emit another photon state into optical link 12A. Method S20 includes loop S23A which is iterated to sequentially transmit photon states into optical link 12A.

Transmission of sequential photon states in the sequence may occur rapidly with delays between transmission of subsequent photon states much shorter than the time-of-flight for a photon from one node to the other. This arrangement allows high utilization of optical link 12A at those times when optical link 12A is available.

In some embodiments station 10 is configured to transmit synchronization information on an optical link. The synchronization information may, for example, be detected at a corresponding node and used by the corresponding node to determine when different photon states are expected to be received from station 10. For example, photon states may be transmitted in time slots that have a pre-determined timing relationship and the synchronization information may be transmitted at times that have a predetermined relationship to the time slots for photon states. For example, timing information may be delivered from station 10 a set time before a first time slot corresponding to a first photon state and the time slots for subsequent photon states may begin at specific times relative to the synchronization information and/or the first time slot.

The synchronization information may, for example, be delivered in the form of laser pulses that have a predetermined timing relationship to the transmission of photon states from station 10. In some embodiments the laser pulses have wavelengths that are different from wavelengths of the photon states such that the laser pulses do not impede transmission and detection of the photon states. In some embodiments the sequence of photon states includes predetermined gaps and laser pulses are delivered from station 10 during the gaps.

In some embodiments synchronization is achieved in whole or part using clocks associated with station 10 and a node to which photon states are to be delivered from station 10. In some embodiments, time of flight of the photon states from station 10 to a node is determined from known relative positions of station 10 and the node (e.g. as determined from global positioning system (GPS) sensors).

At block S24A a quantum system 15 of group 22AC is caused to emit a photon state. After a photon state has been emitted by a quantum system 15, (preferably immediately after transmission of the photon state) the quantum state of the quantum system 15 from which the photon state was emitted is transferred to another quantum system 15 of station 10 (block S25A).

In some embodiments, block S24A comprises emitting plural distinguishable photon states simultaneously or within the same time window. For example, the plural photon states may have different wavelengths, polarizations or the like. The plural distinguishable photon states may be emitted by corresponding ones of a plurality of quantum systems (e.g. 22AC) that are all coupled to deliver photon states into a respective optical link (e.g. 12A). The resulting photon states may be received, separated, and individually processed at a node (e.g. 14A)

FIG. 2 shows a group 22AM of quantum systems 15 (labelled 15AM-1 to 15AM-P) into which quantum states of quantum systems 15AC-1 to 15AC-N may be transferred. Transfer of a quantum state from a quantum system 15AC of group 22AC to a quantum system 15AM of group 22AM may be achieved, for example, by quantum teleportation. The quantum teleportation may consume entanglement of quantum systems 15 of station 10. This quantum entanglement may be created by photon-mediated entanglement distribution controlled by controller 20 internal to station 10.

Quantum entanglement to support quantum teleportation of quantum states within station 10 may be generated in advance (e.g. prior to emission of the corresponding photon state in block S24A). Quantum entanglement to support teleportation of a quantum state from a particular quantum system 22AC to a particular quantum system 22AM may be created directly (e.g. where each of the quantum systems to be entangled to support the quantum teleportation can be optically coupled to a respective optical port of the same BSA) and/or by entanglement swapping. The way(s) that may be available to generate quantum entanglement to support quantum teleportation of specific quantum states within station 10 will, in general, depend on the way in which quantum systems of station 10 are interconnected as well as on the configuration of controller 20. In some embodiments, the quantum systems that are entangled to support quantum teleportation within station 10 comprise or consist of electron spins.

Controller 20 keeps track of which quantum system 15AM of group 22AM corresponds to which photon state in the sequence.

Once a quantum system 15AC of group 22A has emitted a photon state and the quantum state of the quantum system 15AC has been transferred to a corresponding quantum system 15AM of group 22AM, the quantum system 15AC of group 22AC may be re-initialized to an initial quantum state from which the quantum system 15AC may be caused to emit another photon state in the sequence (block S26A). Block S27A determines whether optical link 12A remains available and, if so, whether more photon states should be emitted into optical link 12A.

Node 14A is controlled to attempt to load each of the photon states incoming from station 10 on optical link 12A into the quantum state of a corresponding quantum system 15 of node 14A. Loading of the photon states is attempted using a heralded protocol. In this context, “loading” means causing the corresponding quantum system to have a quantum state that preserves quantum information formerly encoded in the photon state.

Since optical link 12A is lossy, some photon states sent from station 10 will not reach node 14A. Node 14A communicates to station 10 which of the photon states have been successfully received and loaded at node 14A. This may be done in various ways. For example, if node 14 and station 10 have synchronized clocks then node 14 may communicate to station 10 information that indicates when each successfully loaded photon state was received at node 14. This information together with the known time of flight for photons from station 10 to node 14 may allow controller 20 of station 10 to determine which of quantum systems 15AM (or 15BM) correspond to photon states that have been successfully loaded into quantum systems of the node 14. As another example a node 14 may transmit information that includes a sequence number for photon states that were and/or were not successfully loaded into quantum systems of the node 14.

In some embodiments station 10 sends photon states in a protocol by which each photon state is sent in a time slot that has a known duration and starts at a known time relative to the protocol being initiated. Station 10 may send a signal (e.g. a laser pulse) which indicates when the protocol was initiated. In such embodiments node 14A can indicate which photon states were successfully loaded by communicating information (such as an index) that identifies time slots in which photon states were successfully loaded.

Successful loading of a photon state will result in entanglement of the corresponding quantum system 15 of node 14A and the quantum system 15AM of group 22AM into which the quantum state of the quantum system 15AC which emitted the photon state was transferred.

For example, a controller 21A of node 14A may configure node 14A to direct each incoming photon state to an input port of a Bell state analyzer (“BSA”) 25 and to cause the corresponding quantum system 15 of node 14A to emit a photon state that is directed to a second input port of the BSA. A controller 21B of node 14B may be configured to cause node 14B to operate in a similar manner.

Successful loading of the photon state may be determined from outputs of the BSA, and serves as the ‘heralding’ signal. Controller 21A may send a communication (step S28A) to controller 20 of station 10 regarding which photon states received from station 10 were successfully loaded. This communication may be delivered by way of optical link 12A or by a separate communication modality of any type. In response to station 10 receiving a communication indicating that one or more photon states were not successfully loaded at a node 14, controller 20 may coordinate actions to release resources relating to the photon state that was not successfully loaded (e.g. by reinitializing quantum systems 22AM or 22BM that are storing quantum information relating to the photon state as described elsewhere herein). Step S28A may be performed at any time after one or more photon states have been received, or not received at a node 14. Step S28A may be distributed (i.e. may be performed at two or more times. For example, step S28A may be performed initially at a time when one or more photon states have been transmitted to a node 14 and there are photon states still to be transmitted to the node 14. Step S28A may be performed again after the photon states have all been transmitted. Step S28A may optionally be performed at intermediate times.

In some embodiments, each photon state that is successfully loaded at node 14A results in a corresponding pair of entangled quantum systems 15 where one quantum system of the pair is in node 14 and the other quantum system of the pair is in station 10.

Entanglement may be created between quantum systems of station 10 and corresponding quantum systems in node 14B by performing the above methods using optical link 12B to send photon states from station 10 to be loaded into quantum systems of node 14B. In FIG. 2A steps S21B, S22B, S23B, S24B, S25B, S26B, S27B and S28B relate to photon states transmitted on optical link 12B to node 14B and parallel corresponding steps S21A, S22A, S23A, S24A, S25A, S26A, S27A and S28A.

At block S29, method S20 manages memory quantum systems 15AM, 15BM of station 10. For example, for cases where successful loading of a photon state was not detected at block S28A or S28B the corresponding memory quantum system of station 10 may be reinitialized and/or marked as being available to receive quantum states of communication quantum systems 15AC and/or 15BC from which subsequent photon states are transmitted.

FIG. 2 shows for example, group 22BC of quantum systems 15BC-1 to 15BC-N which may be controlled to emit photon states into optical link 12B and a group 12BM containing quantum systems 15BM-1 to 15BM-M that may store quantum states of quantum systems of group 22B that have emitted photon states.

Entanglement of quantum systems in station 10 with quantum systems of node 14B may be performed during a period when optical link 12B is available. This period may be before, after, at the same time as, or in an overlapping time window with the entanglement of quantum systems in station 10 with quantum systems of node 14A.

As soon as at least one pair of a quantum system of node 14A and a first quantum system of station 10 and at least one pair of a quantum system of node 14B and a second quantum system of station 10 are each entangled then entanglement of the quantum system of node 14A and the quantum system of node 14B may be created by entanglement swapping (step S30). The entanglement swapping may, for example, comprise processing the communications received from nodes 14A and 14B to identify one or more candidates for each of the first and second quantum system of station 10 (step 30A), performing a Bell state measurement on the first and second quantum systems of station 10 (step 30B), communicating results of the Bell state measurement to at least one of nodes 14A and 14B (step 30C), and conditionally and optionally, based on the result of the Bell state measurement, adjusting the quantum state of one of the quantum system of node 14A and the quantum system of node 14B (step 30D).

The Bell state measurement may, for example be performed using a BSA 25 of station 10. Station 10 may include one or more BSAs 25. Station 10 may include a switching network configurable to direct photons from the first and second quantum systems to a BSA 25. FIG. 2 shows an example case in which the switching network includes optical switches or multiplexers 27A and 27B. For example, an optical switch 27A may be configured to deliver a photon state from any one of quantum systems 15AM to BSA 25 and an optical switch 27B may be configured to deliver a photon state from any one of quantum systems 15BM to BSA 25. Depending upon the construction of BSA 25 and the protocol used to perform Bell state measurements, the Bell state measurements may be “partial” (e.g. measurements which project into either one, or one of two of the four Bell states or fail) or “full” (e.g. measurements which project into any of the four Bell states). Full Bell state measurements have a greater probability of success than partial Bell state measurements (if other factors such as photon loss are equal).

In some embodiments, Bell state measurements between first and second quantum systems of station 10 are performed indirectly using a pair of entangled quantum systems of station 10. For example, Bell state measurements may be performed between the first quantum system and a first one of the pair of entangled quantum systems as well as between the second quantum system and a second one of the pair of entangled quantum systems. This combination of Bell state measurements, if successful, is equivalent to performing a Bell state measurement between the first and second quantum systems. In some embodiments the first quantum system is coupled (e.g. by hyperfine coupling, spin-orbit coupling etc.) to the first quantum system of the entangled pair of quantum systems and/or the second quantum system is coupled to the second quantum system of the entangled pair of quantum systems such that local Bell state measurements (e.g. implemented by applying quantum gates) may be performed without the need for a BSA.

In some embodiments, the first (second) quantum system and the first (second) one of the pair of entangled quantum systems may be provided by spins within the same microstructure (e.g. the same luminescent center). For example, the first (second) quantum system may comprise a nuclear spin and the first (second) one of the pair of entangled quantum systems may comprise an electron spin or hole spin of a T centre. Entanglement of the entangled pair of quantum systems may be achieved in any suitable manner (e.g. by performing a Bell state measurement, using BSA 25, entanglement swapping, etc.).

After the Bell state measurement has been performed, the first and second quantum systems of station 10 may be reinitialized (step S32). Reinitialization may, for example comprise pumping an optical transition of the quantum system for a period of time sufficient to place the quantum system in a known quantum state with high probability. Step S32 may reinitialize quantum system involved in an unsuccessful entanglement distribution attempt for reuse.

Step S33 determines whether there are more entanglement swaps to be performed. If YES, method S20 returns to step S33, otherwise, method S20 proceeds to step S34 which pauses, restarts or ends execution of method S20.

The entanglement shared by nodes 14A and 14B may be consumed as a resource for operations such as quantum communication, quantum sensing, quantum key distribution, or any other quantum application. In some embodiments the method provides entanglement of each of plural quantum systems or one node with a corresponding one of plural quantum systems of another node. These plural entanglements are optionally distilled to yield a smaller number of higher fidelity entangled states.

Advantageously station 10 may distribute entanglement to nodes 14A and 14B asynchronously. It is not necessary for optical links 12A and 12B to be available simultaneously. If optical links 12A and 12B are available simultaneously then station 10 may also distribute entanglement to nodes 14A and 14B synchronously.

The quantum systems (e.g. 15AM, 15BM) in which quantum states are stored should have sufficiently long lifetimes (long decoherence times) so that the entanglement persists until photon state transmission across quantum links 12A and 12B to both of nodes 14A and 14B has succeeded.

In some embodiments the lifetimes of quantum systems 15AM, 15BM are enhanced by dynamical decoupling and/or quantum error correction techniques.

Once both end nodes have successfully loaded/detected photons (possibly asynchronously), the Bell state analyzer is configured to perform a Bell state measurement (BSM) between memory quantum systems associated with the respective end node to thereby transfer entanglement between storage spin and end node to entanglement between the end nodes.

Quantum systems 15AM and/or 15BM that correspond to photon states that were not successfully loaded at the respective one of nodes 14A, 14B may be reinitialized.

The control system which coordinates operation of station 10 may include one or more controllers (e.g. 20, 21A, 21B). Controllers according to various embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing to control system 100 may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, optical links 12 and/or other data communication channel.

### Examples of Quantum Systems

In some embodiments, each of quantum systems 15 comprises an intrinsic spin of a particle (e.g. an electron, a hole or an atomic nucleus). In some embodiments quantum systems of group 22A (22B) are different from quantum systems of groups 22AM (22BM). For example, the quantum systems of groups 22AM and 22BM may be selected to have a longer characteristic decoherence time than the quantum systems of groups 22A and 22B. For example, the quantum systems of groups 22A and 22B may comprise electron spins while the quantum systems of groups 22AM and 22BM may comprise nuclear spins.

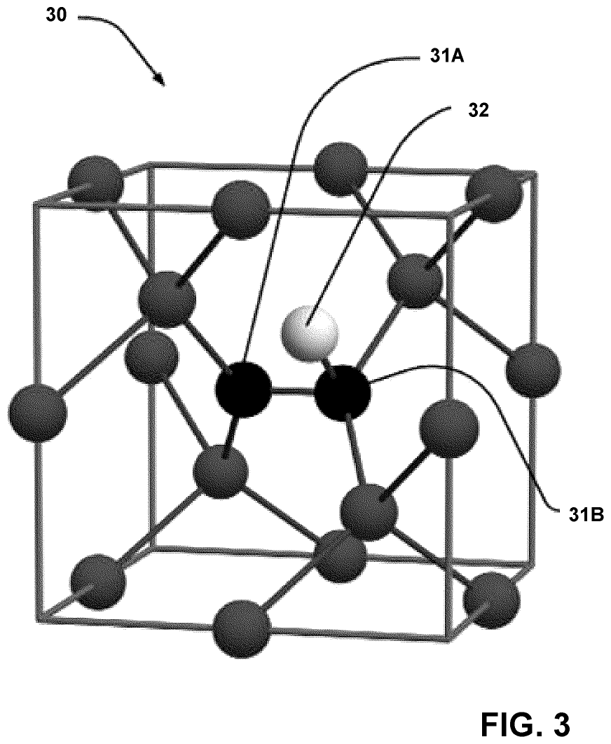

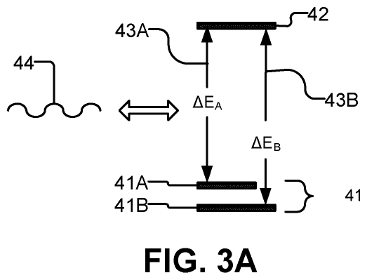

In some embodiment, quantum systems 15 are provided by electron spins and nuclear spins of T centres. FIG. 3 is a perspective view of a model which shows the structure of a T centre 30. The T centre 30 is a structure in which a silicon atom in a silicon crystal has been replaced by two carbon atoms 31A and 31B and a hydrogen atom 32 bonded to carbon atom 31B. Carbon atom 31A has one unpaired electron. The spin state of the unpaired electron (which has spin %) of carbon atom 31A may be used as a communication quantum system (e.g. 15A or 15B). The nucleus of hydrogen atom 32 (which has spin %) may serve as a quantum memory (e.g. 15AM or 15BM).

In some embodiments, one or both of the carbon atoms in a T centre are the carbon isotope ¹³C. Nuclei of carbon-13 atoms have a spin of ½ and may be used as additional quantum memories (by contrast, nuclei of the carbon isotope ¹²C do not have a net spin).

T centres have properties that make their spins particularly good for use as storing quantum information. These properties include:
T centres exhibit long characteristic spin decoherence times (>2.1 ms electron and >1s nuclear spin);
T centres have narrow optical linewidths (<30 MHz);
T centres can couple to O-band photons (wavelengths including about 1326 nm);
A T centre can provide multiple (e.g. up to 4) accessible spin manifolds;
A T centre couples weakly but controllably to lattice strain;
A T centre couples weakly but controllably to electric fields;
A T centre can support excitons which may be used to store quantum information (e.g. in hole spins).

The spins in a T centre can be accessed optically through energy transitions between the T ground state and a bound exciton excited state known as TX0. The transition from the T ground state to the TX0 state involves the creation of a bound exciton, which contains an electron and hole. The electron spin of the exciton combines with the original ground state electron spin to form a singlet. During optical transitions between the T ground state and TX0 excited state, emitted photons can be entangled to the electron/hole spin state.

The transition between the T ground state and the TX0 state has an energy that corresponds to photons having wavelength of 1326 nm, which is conveniently in the telecommunications O-band.

Where a quantum system 15A or 15B comprises a spin, photon states emitted by the quantum system may be spin entangled. For example, FIG. 3A is a simplified schematic energy level diagram for an example spin in the presence of a magnetic field. The spin has a ground state 41 and an excited state 42. The ground state has an energy level 41A corresponding to spin up and energy level 41B corresponding to spin down. An energy E_{A} is required to cause a transition 43A from level 41A to excited state 42. An energy E_{B} is required to cause a transition 43B from level 41B to excited state 42 E_{A}≠E_{B}. If the spin is illuminated by photons 44 having an energy equal to E_{A} then a transition to the excited state is possible but only from level 41A. From the excited state the spin can transition back to the ground state, emitting a photon state in the process.

A spin, being a quantum system, may have a quantum state corresponding to spin up (|↑ [symbol] ), spin down (|↓ [symbol] ), or a superposition of spin up and spin down as represented by equation (2). If the spin is initialized in a superposition of spin up and spin down such as (|↑ [symbol] +|↓ [symbol] )/\sqrt{2} or (|↑ [symbol] −|↓ [symbol] )/\sqrt{2} then the photon state resulting from illuminating the spin with light having a wavelength corresponding to E_{A} will be a superposition of a photon being present and a photon not being present (this is an example of a “spin-entangled photon”).

### Example Implementation with Quantum Spins

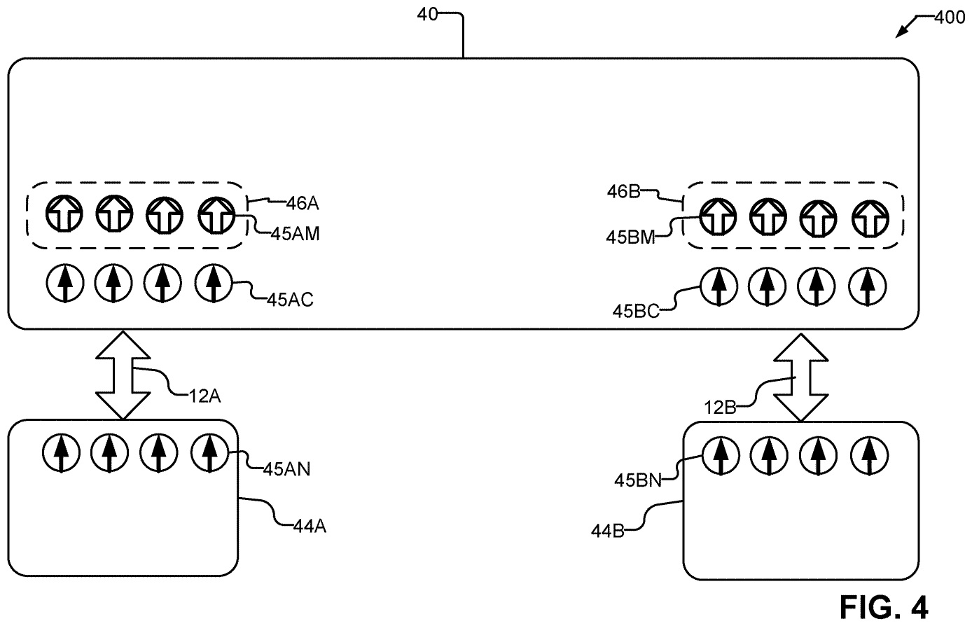

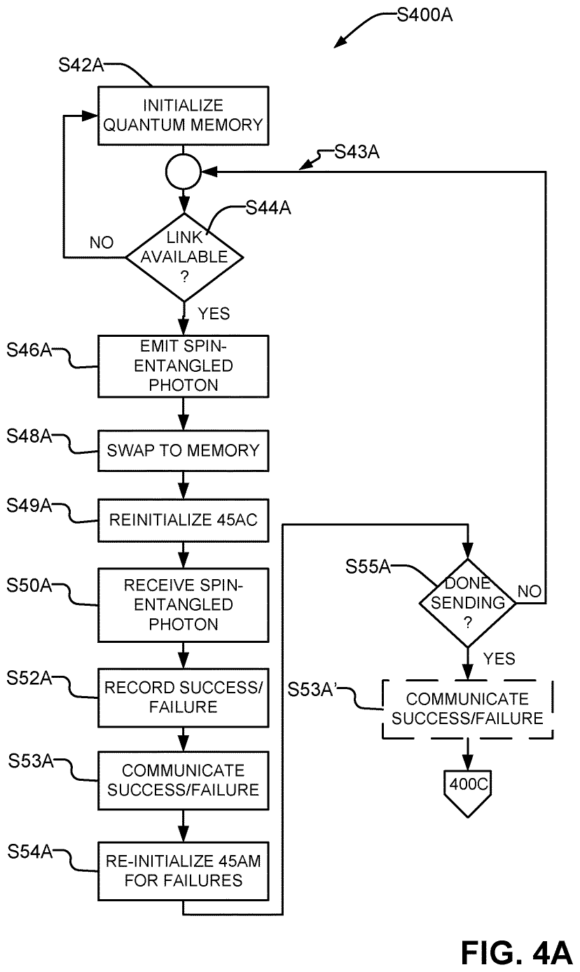

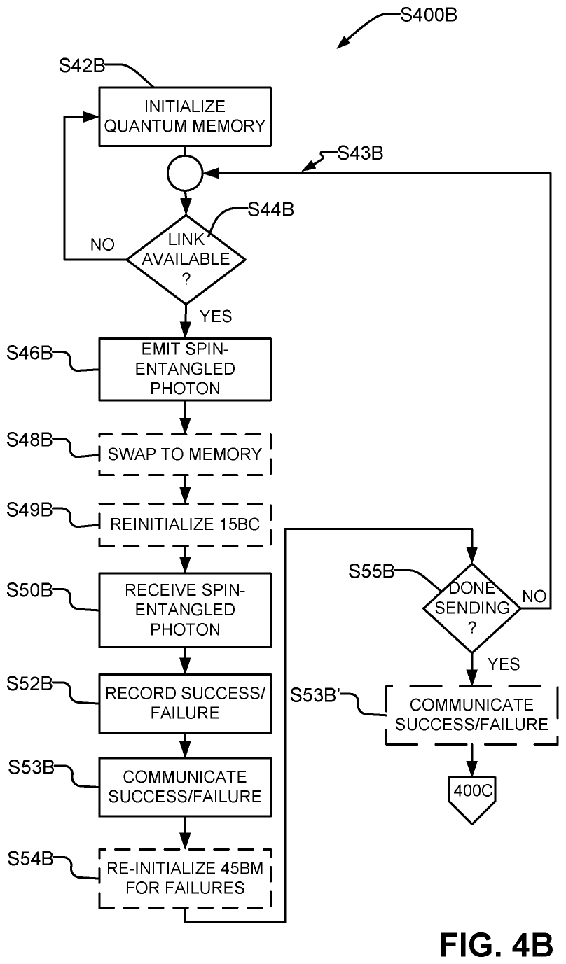

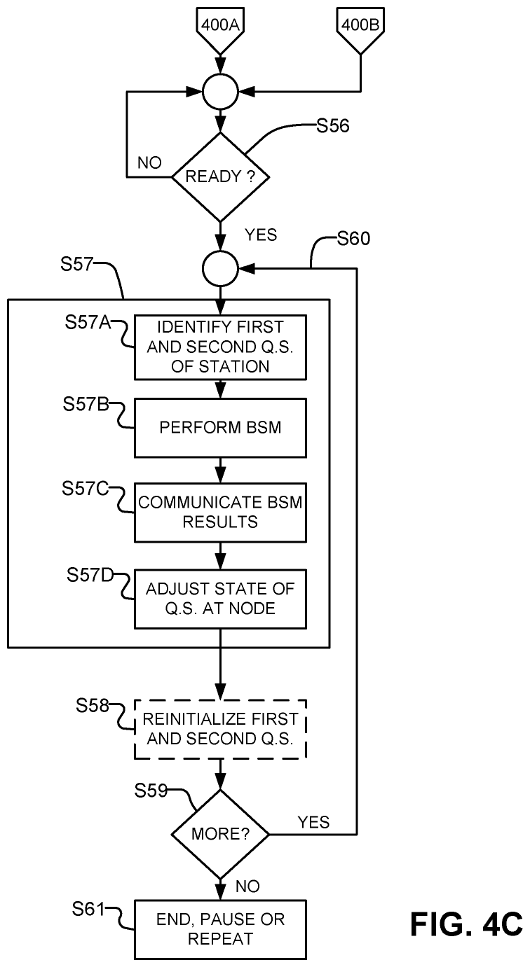

FIG. 4 is a schematic illustration of an example system 401 according to an embodiment of the invention in which quantum systems are provided by intrinsic spins of particles such as electrons or atomic nuclei. System 401 includes a station 40 communicatively coupled to nodes 44A and 44B by optical links 12A and 12B. Station 40 includes a plurality of quantum systems 45AC that are associated with optical link 12A and a plurality of quantum systems 45BC that are associated with optical link 12B. Optical links 12A and 12B may comprise channels provided by optical fibers or other optical waveguides or free space. Optical links 12A and 12B may have the same or different constructions.

In this example, each of quantum systems 45AC and 45BC comprises an electron spin. Each of quantum systems 45AC is controllable to emit a spin-entangled photon into optical link 12A. Each of quantum systems 45BC is controllable to emit a spin-entangled photon into optical link 12B.

System 401 also includes quantum memories 46A and 46B. Each of quantum memories 46A and 46B is operable to store a plurality of quantum states. The quantum states may, for example, be qubit states. Each qubit state may comprise an arbitrary superposition of two qubit basis states. The qubit states may be spin states.

In example system 401, memory 46A is made up of quantum systems 45AM and memory 46B is made up of quantum systems 46BM. Each of quantum systems 46AM and 46BM comprises an intrinsic spin. In some embodiments each of quantum systems 46AM and 46BM comprises a nuclear spin. Each nuclear spin may have a quantum state that can be one of or a superposition of two qubit basis states such as |≈ (nuclear spin-up) and |≈ (nuclear spin-down).

In example system 401, nodes 44A and 44B respectively include plural quantum systems 45AN and 45BN. Quantum systems 45AN and 45BN may, for example comprise electron spins. In some embodiments, quantum systems 45AN and/or 45BN comprise luminescent centers that comprise both an electron spin and one or more nuclear spins. The luminescent centers may, for example, comprise T centres.

FIGS. 4A, 4B and 4C are flow charts that collectively illustrate a method 400 for creating entanglement of quantum systems of two nodes of a system 401 of the general type illustrated in FIG. 4.

FIG. 4A shows a portion S400A of method 400 that creates entanglement between quantum systems of station 40 and quantum systems of node 44A. FIG. 4B shows a portion 400B of method 400 that creates entanglement between quantum systems of station 40 and quantum systems of node 44B. FIG. 4C shows a portion 4000 of method 400 that swaps entanglement of two pairs of entangled quantum systems respectively created in portions 400A and 400B to provide entanglement between quantum systems of nodes 44A and 44B.

Portions 400A and 400B of method 400 may be performed sequentially in any order, in parallel (i.e. during time periods that overlap) or simultaneously. Where portions 400A and 400B are being executed concurrently, execution of portions 400A and 400B may be synchronized or asynchronous.

Portion 4000 may be performed at any time after portions 400A and 400B have each created entanglement between a quantum system of station 10 and a quantum system of the corresponding node 44A or 44B. In some embodiments, portion 4000 is performed after both portions 400A and 400B are complete. In some embodiments portion 4000 is commenced while one or both of portions 400A and 400B is being executed.

At step S42A, quantum memory 46A is initialized. Initialization results in quantum systems 45AM of quantum memory 46A being placed in a desired quantum state. Initialization may, for example comprise optical pumping and microwave spin operations which place each of quantum systems 45AM in a desired initial state.

Step S44A determines whether optical link 12A is available for communication. Step S44A may, for example, comprise looking up a schedule that indicates times that optical link 12A is available, determining a relative position of station 40 and node 44A and applying a criterion to determine whether optical link 12A is available for the relative position, measuring or looking up atmospheric conditions in the case that optical link 12A extends through free space, detecting light that has been emitted into one end of optical link 12A at another end of optical link 12A and/or monitoring characteristics of optical link 12A such as a noise level, signal to noise level, or attenuation of optical link 12A.

In some embodiments, if step S44A determines that optical link 12A is not available, method 400 determines whether there is an alternative optical link by way of which photon states may be delivered from station 10 to node 44A.

When optical link 12A (or a substitute optical link) is available, method 400 proceeds to step S46A. Step S46A causes a communication spin of a quantum system 45AC in station 40 (e.g. an electron spin) to emit a spin-entangled photon into optical link 12A. In some embodiments, step S46A comprises configuring optical switches or other optical components of station 10 to direct the spin-entangled photon from the quantum system 45AC into optical link 12A.

In some embodiments, step S46A comprises setting a condition of the communication spin of the quantum system 45AC to control the nature (e.g. polarization, wavelength) of a photon state emitted by the quantum system 45AC. For example, wavelength of the spin entangled photon may be adjusted by setting a magnitude of a magnetic field, electric field, or strain in a substrate at the location of the quantum system 45AC.

Causing the communication spin 45AC to emit the spin-entangled photon may, for example, comprise applying one or more of a magnetic field, an electric field, a radiofrequency (RF) signal such as a microwave pulse, or an optical pulse to the communication spin, thereby causing the communication spin to undergo an optical transition and to emit the spin-entangled photon as a consequence of the optical transition.

At step S48A, the spin state of the communication spin is transferred (e.g. swapped) to quantum memory 46A. The mechanics of step S48A may depend on the relationship of the quantum system 45AC that emitted the photon state and the quantum system 45AM into which the spin state of the quantum system 45AC is to be swapped. For example:
where the quantum system 45AC and the quantum system 45AM are coupled to one another (e.g. by hyperfine coupling, spin-orbit coupling or the like) as, for example may be the case where the quantum system 45AC is an electron spin of a T centre or other luminescent center and the quantum system 45AM is a nuclear spin of the same T centre or other luminescent center, then swapping the spin state of quantum system 45AC to quantum system 45AM may comprise applying appropriate microwave, other RF, and/or optical control pulses to the T centre or other luminescent center.
the spin state of the quantum system 45AC may be teleported to quantum system 45AM using a quantum teleportation protocol. The quantum teleportation protocol may, for example use entanglement of the quantum system 45AM and another quantum system. The quantum teleportation protocol may, for example, comprise performing a Bell state measurement between the quantum system 45AC and the another quantum system and applying a quantum gate to the quantum system 45AM that is selected based on results of the Bell state measurement.

Step S49A reinitializes the quantum system 45AC that emitted the spin-entangled photon. Step S49A may, for example comprise optical pumping.

Step S50A receives the spin-entangled photon at node 44A from optical link 12A. In some embodiments, steps S48A and S50A are performed in parallel. Step S52A determines whether the spin-entangled photon was successfully received at node 44A.

In some embodiments, step S52A comprises executing a heralded probabilistic entanglement protocol with a selected quantum system 45AN of node 44A. If success of the entanglement is heralded, it is known that the spin-entangled photon was received at node 44A and also that the selected quantum system 45AN is entangled with the quantum system 45AC which emitted the photon state at station 40. For example, step S52 may comprise performing an optical Bell state measurement between the spin entangled photon and a photon emitted by the selected quantum system 45AN. In some embodiments step S52 comprises executing a strong coupling protocol between the spin-entangled photon and the selected quantum system 45AN. For example, the strong coupling protocol may comprise delivering the spin entangled photon toward a cavity to which the selected quantum system 45AN is optically coupled followed by photon detection to detect the spin-entangled photon. For example, step S52 may comprise the technique described in Heralded Storage of a Photonic Quantum Bit in a Single Atom Phys. Rev. Lett. 114, 220501 (2015)—(aps.org) or Experimental demonstration of memory-enhanced quantum communication Nature 580, pp. 60-64 (2020), which is hereby incorporated herein by reference for all purposes.

Step S53A communicates the results of step S52 to station 40. It is not necessary that step S53A is executed every time step S52 is executed. In some embodiments, step S53A is executed only in some iterations of loop S43A. In some embodiments, step S53 is executed after loop S43A terminates as indicated by S53A′.

Step S54A re-initializes those quantum systems S45AM which correspond to generated spin-entangled photons that were not successfully received at node 44A (e.g. because the spin-entangled photon was lost or a probabilistic entanglement protocol failed).

Step S55A determines whether or not to continue iterating loop S53A. Steps S42A to S55A may be repeated by iterating loop S53A for as long as optical link 12A remains available or until all of the available quantum systems 45AM of memory 46A are each entangled with a corresponding quantum system 45AN of node 44A or all of the available quantum systems 45AN of node 44A are each entangled with a corresponding quantum system 45AM of memory 46A or a desired number of quantum systems 45AN of node 44A are each entangled with a corresponding quantum system 45AM of memory 46A.

If step S55A determines that no more iterations of loop S53A are required then portion 400A proceeds to portion 4000.

The steps of portion 400B are essentially the same as the steps of portion 400A except that the steps are referenced by numbers having the suffix B and spin-entangled photons are generated by one of quantum systems 45BC and delivered to node 44B by optical link 12B where they create entanglement with quantum systems 45BN and spin states of quantum systems 45BC are stored in quantum systems 45BM of memory 46B.

In some embodiments, particularly when portion 400B is executed after portion 400A, steps S48B, S49B and S54B are omitted.

Portions 400A and 400B of method 400 may be performed simultaneously or sequentially in any order or at overlapping times. The desired outcome of portions 400A and 400B are pairs of entangled quantum systems. For portion 400A, in each entangled pair, one of the quantum systems is in node 44A and one of the quantum systems is in station 40. For portion 400B, in each entangled pair, one of the quantum systems is in node 44B and one of the quantum systems is in station 40.

When portions 400A and 400B have each created entanglement then portion 4000 may commence execution as long as the fidelity of the entanglement exceeds a threshold. If too much time has elapsed since some of the entanglement was created, decoherence of the quantum systems that share the entanglement may have caused the fidelity of the entanglement to have dropped below a threshold level. In some embodiments entanglement distillation is performed to improve the fidelity of the entanglement to a useful level. In other cases it may be necessary to restart method 400 and/or to reinitialize those quantum systems that are entangled with undesirably low fidelity.

It is not mandatory that both of portions 400A and 400B are complete when portion 4000 commences execution. In some embodiments one or both of portions 400A and 400B are still executing when portion 4000 is invoked. Step S56 determines whether each of portions 400A and 400B has produced enough entangled pairs to commence execution of portion 4000.

Step S57 performs entanglement swapping to create entanglement between one quantum system 45AN of node 44A and one quantum system 44BN of node 44B. Step S57 may be iterated and/or instances of step S57 may be performed in parallel to create plural pairs of entangled quantum systems 45AN and 45BN. FIG. 4C illustrates the case where loop S60 is iterated until a desired number of entangled pairs of quantum systems 45AN and 45BN have been generated or no more pairs of entangled quantum systems 45AN and 45BN can be generated.

Step S57 may, for example comprise step S57A which identifies two quantum systems of station 40 that may be used to generate entanglement between a pair of quantum systems comprising a quantum system 45AN and a quantum system 45BN. Step S57A may, for example use information communicated in steps S53A, S53A′, S53B, S53B′ to identify one quantum system 45AM of station 10 that was successfully entangled to the quantum system 45AN of node 44A and to identify a quantum system 45BM or 45BC that was successfully entangled with the quantum system 45BN of node 44B.

Step S57B comprises performing a Bell state measurement (BSM) between the quantum system 45AM that is entangled with the one quantum system 45AN of node 44A and the quantum system 45BM (or 45BC) that is entangled with the one quantum system 45BN of node 44B. The BSM may, for example, be accomplished by RF, microwave, and/or optical control pulses followed by spin readouts, if the quantum systems 45AM and 45BM are coupled (e.g. both within the same T centre). As another example, the BSM may be accomplished by effecting a remote BSM between the quantum systems S45AM and S45BM. This may be done, for example by entangling a pair of quantum systems of station 40 that are respectively coupled to the quantum systems 45AM and 45BM and performing two BSMs, one of the BSMs between the quantum system 45AM and one member of the entangled pair of quantum systems of station 40 and the other one of the two BSMs between the quantum system 45BM and the other one of the entangled pair of quantum systems of station 40.

Step S57C communicates results of the BSM of step S57B to at least one of nodes 44A and 44B. This communication of one or more bit values representing results of the BSM of step S57 may be delivered by way of optical link 12A and/or 12B or any other communication channel operable to convey the bit values.

Step S57D conditionally corrects the state of one of the qubits stored in quantum system 45AN or 45BN by performing selective qubit rotations based on the information about the BSM results communicated by step S58. These qubit rotations may be, for example as described in Charles H. Bennett, Gilles Brassard, Claude Crepeau, Richard Jozsa, Asher Peres, and William K. Wootters, Teleporting an unknown quantum state via dual classical and Einstein-Podolsky-Rosen channels, Phys. Rev. Lett. 70, 1895—Published 29 Mar. 1993.

In some embodiments, if a first one of portions 400A and 400B is completed or has progressed further than a second one of portions 400A and 400B, then in the second one of portions 400A and 400B, step S48A or S48B as applicable, may be skipped. In such embodiments the entanglement created at step S52A or S52B, as applicable, remains between a quantum system 45AC and a quantum system 45AN or between a quantum system 45BC and a quantum system 45BN, and step S57B may be performed between a quantum system 45AC and a quantum system 45BM or between a quantum system 45BC and a quantum system 45AM. Whether this approach is viable may depend on the decoherence times of quantum systems 45AC, 45BC, 45AM and 45BM. Typically where quantum systems 45AC and 45BC are provided by electron spins and quantum systems 45AM and 45BM are provided by nuclear spins, the nuclear spins will have significantly longer decoherence times than the electron spins. Step S57B must be performed before the entangled quantum states of the quantum systems that step S57B acts on decohere.

Step S58 optionally reinitializes the first and second quantum systems of the station. Step S59 determines whether more entanglement can and should be created. If so, loop S60 is iterated. Otherwise, portion 4000 proceeds to step S61 which ends, pauses or repeats method 400.

Method 400 may be coordinated by a control system which is operative to cause quantum systems 45AC and 45BC to emit spin-entangled photons respectively into optical links 12A and 12B at desired times (e.g. by optically exciting quantum systems 45AC and 45BC), swap quantum states of quantum systems 45AC and/or 45BC to corresponding quantum systems 45AM or 45BM); generate entanglement of the quantum systems 45AC and 45BC with quantum systems 45AN and 45BN respectively (e.g. by performing Bell state measurements at nodes 44A and 44B); and swap the entanglement to be between quantum systems 45AN and 45BN (e.g. by performing a BSM at station 40). The control system may, for example, include controllers at station 40 and nodes 14 that communicate by way of optical links 12 and/or other communication channels and cooperatively coordinate execution of the described methods.

### Example Satellite Implementation

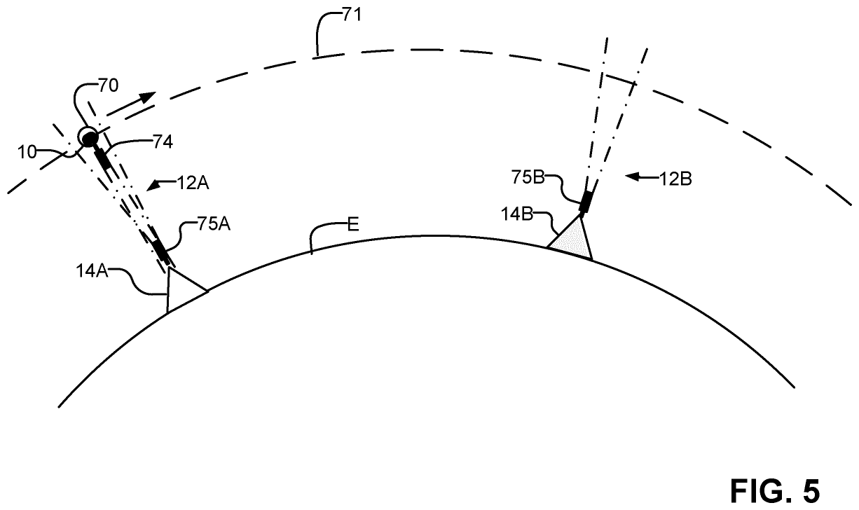

FIG. 5 illustrates an example case where station 10 is carried by a satellite 70 that orbits the earth E on an orbit 71. In this example, orbit 71 is an orbit in which satellite 70 and station 10 are moving relative to the surface of the earth. For example, orbit 71 may be a low earth orbit. Satellite 70 may, for example, orbit the earth in 128 minutes or less.

At least one of nodes 14A and 14B is provided by a ground station that orbit 71 passes close enough to for optical communication. Optical links 12A and 12B are line-of-sight free space paths between a telescope 74 carried by satellite 71 and a telescope, 75A or 75B at the respective node 14A, 14B.

In some embodiments one of optical links 12A or 12B is to another satellite. In some embodiments the satellites are part of a constellation in which optical links between the satellites are continuously or intermittently available.

In some embodiments a system that includes stations and nodes carried by satellites may establish entanglement of quantum systems at nodes that are widely spaced-apart on the surface of the earth. For example, entanglement may be created between satellite-based stations and nodes as described herein by way of free-space optical links that extend outside of the earth's atmosphere. Entanglement may be extended to the earth-based nodes as described herein. Entanglement swapping may be performed to generate entanglement of quantum systems at the widely spaced apart earth based nodes.

The following discussion considers the case where nodes 14A and 14B are each located at a ground station. The movement of the satellite around its orbit causes optical links 12A and 12B to become available and unavailable as direct lines of sight are established or lost. Each ground station (node) may, for example, be in view of the satellite for periods having a duration of approximately 100 s while the satellite passes over the vicinity of the ground station.

A typical roundtrip signal time between the low-earth orbit (LEO) satellite and a ground station is about 6.6 ms. To optimize the communication rate, a full register (22AM, 22BM, 46A, 46B) of quantum memories (15AM or 15BM) may be filled in a single satellite pass over each node 14. Entanglement of qubits of an example 1000-spin quantum memory register with corresponding qubits of a ground station node 14 in 100 seconds may be achieved, for example, by emitting photon states into an optical link 12 at a rate of least about 150 kHz in the case where an average loss of the free-space optical link 12 is 41 dB or more. In some embodiments, optical links 12 have loss of 45 dB or lower. Larger quantum memories (whether in the form of spins or another type of quantum system), such as 10,000 qubits and more, could be addressed either with faster interaction times or optical multiplexing.

### Advantages of Some Embodiments

It can be appreciated that the described methods can be implemented in ways that efficiently utilize periods of availability of optical links 12A and 12B (which may be short periods) and do not require optical links 12A and 12B to be simultaneously available. Photon states (e.g. spin-entangled photons) can be transmitted in rapid succession. It is not necessary to wait for a round trip time of an optical link 12A or 12B between transmitting sequential photon states into the optical link. The optical link may be utilized even in cases where the optical link is available for a period that is shorter than the round trip time for the optical link.

Where there are enough communication quantum systems (e.g. 15AC, 15BC, 45AC, 45BC) to create a desired number of entangled pairs of quantum systems without reusing any of the communication quantum systems then the rate at which photon states may be transmitted into an optical link 12 is only limited by:
the time required by a node (e.g. 14 or 44) to prepare to accept the next photon state after one photon state has been received (e.g. the time required to operate an optical switch in order to set the node up to perform a BSM between the next photon state and the next one of quantum systems at the node—e.g. the next quantum system 15AN, 45AN, 15BN or 45BN as the case may be).
the time that may be required to couple a next communication quantum system of station 10 or 40 to deliver a photon state into the optical link 12 (e.g. by reconfiguring an optical switch).
the temporal separation between successive photon states required to distinguish between the successive photon states (no temporal separation is necessary—e.g. photon states may be transmitted simultaneously—if the photon states are distinguishable—e.g. where the photon states have different wavelengths)

Since subsequent photon states can be emitted by different quantum systems the temporal separation between subsequent photon states may be shorter than the time required to reinitialize a quantum system and cause the quantum system to emit another photon state. This facilitates “rapid fire” transmission of photon states across an optical link 12.

In some embodiments communication quantum systems of station 10 or 40 are reinitialized and reused. In such embodiments the number of communication quantum systems may be less than the number of memory quantum systems (e.g. 25AM, 15BM, 45AM or 45BM).

The numbers of communication quantum systems and memory quantum systems may be selected to satisfy performance requirements. In some embodiments stations 10, 40 and/or nodes, 14, 44 each contain tens, hundreds, thousands or even millions of memory quantum systems. In some embodiments stations 10, 40 and/or nodes, 14, 44 each comprise some number of memory quantum systems and a smaller number of communication quantum systems.

Consider, for example, the case where subsequent photon states are separated by a time of at least tₛ (due to a maximum rate that station 10 or 40 can emit subsequent photon states and/or a maximum rate that a node 14 or 44 can receive subsequent photon states), the time required to swap the quantum state of a communication quantum system to a memory quantum system is t_{M} and the time required to re-initialize a communication quantum system is t_{R} and there are N available communication quantum systems. In this case, as long asN×tₛ>t_{M}+t_{R} the number of available communication quantum systems will not limit the rate at which subsequent photon states can be continuously sent.

Optical links 12 are not necessarily available for the entire roundtrip time (i.e. the time required for a photon to propagate in both directions through the optical link 12). Communications regarding which photon states were or were not successfully received at a node 14 or 44 may be carried by communication channels other than the optical link 12 and may be communicated at times when the optical link 12 is no longer available. The communication channels for such communications may be classical communication channels. For example, the communication channels may comprise optical communication channels, radio channels, channels that carry electrical signals or the like. Many photon states may be sent within the duration of time for which an optical link 12 is available.

### Quantum Key Distribution (QKD)

A system as described herein may be used for QKD. Various modes of QKD are possible. For example, photon states which carry information that may be used in constructing a raw encryption key may be sent from station 10 to nodes 14, from nodes 14 to station 10 or from one node 14 to the other node 14 via station 10. In some embodiments secure QKD to nodes 14 is possible even if station 10 is not trusted. In some embodiments a trusted station 10 distributes keys.

For some modes of QKD it is not mandatory that nodes 14 include quantum memories. For example, nodes 14 may include optical detectors that are operable to make measurements of photon states together with classical memories that store results derived from the measurements. Where nodes 14 do include quantum memories it is alternatively possible to load photon states incoming from station 10 into the quantum memories and subsequently perform the measurements on the quantum memories.

For quantum key distribution station 10 may emit photon states to each of nodes 14A and 14B. The photon states are respectively entangled with the quantum states of quantum systems (e.g. 22AC or 22BC) of station 10 from which the photon states are emitted.

In some embodiments the photon states are time-bin encoded (i.e. are superpositions of photons in different time bins (e.g. a first time bin and a second time bin that is delayed relative to the first time bin). In some embodiments the photon states are generated using a protocol such as described in Barrett and Kok, Efficient high-fidelity quantum computation using matter qubits and linear optics, Phys. Rev. A 71, 060310(R) (2005). Such protocols cause a first spin-selective emission from a quantum system, apply a spin-flip operation to the quantum system and then cause a second spin-selective emission from the quantum system. Thus the photon states are in one of the basis states “early time bin” or “late time bin” or in a superposition of the early and late time bins.

Nodes 14A and 14B may measure the respective photon states in respective measurement bases. For example, each measurement may be relative to one of a plurality of pairs of basis states (e.g. “mutually-unbiased bases”). The plural pairs of basis states may be selected so that any measurement that can measure a binary value encoded using one of the pairs of basis states will yield a random result when that measurement is applied to a binary value that was encoded using another one of the pairs of basis states. The measurement basis used for each measurement at each node is chosen randomly or in a way that appears random to an observer outside of the node.

A BSM is performed on the quantum systems of station 10 with which the photon states were respectively entangled (e.g. between a quantum system 22AC from which one of the photon states was emitted or a quantum system 22AM to which the quantum state of the quantum system 22AC was transferred and a quantum system 22BC from which the other one of the photon states was emitted or a quantum system 22BM to which the quantum state of the quantum system 22BC was transferred). Results of the BSM indicate whether the photon states are correlated or anti-correlated when measured in the same basis.

The BSM may be performed before, after or between the measurements made at nodes 14A and 14B. The BSM may be made before or after the photon states are emitted. Particularly in cases where optical links 12A and/or 12B have the property that there is a significant probability that a photon state emitted into the optical link will not be successfully measured at a corresponding node it can be desirable, for efficiency, to perform the BSM after the respective photon states have both been received and measured at nodes 14A and 14B respectively.

After nodes 14A and 14B have measured the photon states, one or both of nodes 14A and 14B may share with the other one of notes 14A and 14B information about their choices of basis states for the measurements. For greatest security the information regarding the basis states is shared only after the BSM has been performed.

Nodes 14A and 14B may identify pairs of photon states that were measured in the same basis and, based on a result of the BSM and the result of their own measurement, can each know the result of the corresponding measurement made by the other node 14B or 14A. Nodes 14A and 14B may discard or ignore information regarding pairs of photon states that were not measured in the same basis.

Some embodiments perform the BSM by applying the double heralded entanglement protocol as described in Barrett and Kok Efficient high-fidelity quantum computation using matter qubits and linear optics, Phys. Rev. A 71, 060310(R) (2005) which is hereby incorporated herein by reference for all purposes to the quantum systems with which the photon states were respectively entangled.

The BSM may be performed before or after the photon states have been emitted. In some embodiments the BSM is performed after measurements of both corresponding photon states have been made at nodes 14A and 14B. In some embodiments the BSM is performed prior to measurement of at least one of the corresponding photon states. Station 10 communicates results of the BSM to at least one of the nodes 14.

The results of the measurements at nodes 14 combined with the results of the BSMs made at station 10 may be used at a node 14 to create a shared raw encryption key that may optionally be refined to provide an encryption key as is known in the art. For example, each measurement may be associated with a binary value (0 or 1) and binary values from successful measurements in the same basis may be concatenated to provide a raw key.

Where nodes 14A and 14B measure entangled photon states, the results of the measurements made at nodes 14A and 14B are correlated with the quantum states of the quantum systems (e.g. 22AC or 22BC) of station 10 from which the photon states were emitted. If the same basis is used to make the measurements at nodes 14A and 14B then a BSM made between quantum systems 22AC and 22BC (or between other quantum systems to which the quantum states of quantum systems 22AC and 22BC were transferred) indicates a correlation between the results of the measurements made at nodes 14A and 14B. Since station 10 only disseminates BSM outcomes to nodes 14A and 14B and does not have access to results of the measurements on photon states made by nodes 14A or 14B, a station 10 that is untrusted may be used without compromising the security of the QKD process.

In some embodiments, photon states sent by station 10 are associated into pairs after the photon states have been transmitted. The pairs of photon states may be assigned based on which photon states each of nodes 14A and 14B received and measured. For each of the pairs of photon states, a Bell state measurement may then be performed on a pair of the quantum systems of station 10 that corresponds to the pair of photon states. In such embodiments station 10 may provide BSM information to one or both nodes. The nodes may share information regarding the respective bases each node used to measure a photon state of each pair. One or both of nodes 14A and 14B may each use results of measurements of the photon states, together with corresponding Bell state measurement information and information regarding the measurement basis used by the other node to generate a raw encryption key.

In an alternative mode of QKD station 10 may emit photon states that encode binary values (that can be represented for example by 1 or 0). For example, the photon states that are respectively directed to nodes 14A and 14B may be emitted from different quantum systems of station 10. For example, each binary value may be encoded using one of a plurality of pairs of basis states. The plural pairs of basis states may be selected so that any measurement that can be used to decode a binary value encoded using one of the pairs of basis states will yield a random result when that measurement is applied to a binary value that was encoded using another one of the pairs of basis states. When this mode is used station 10 must be “trusted” as station 10 has access to the binary values that are encoded in photon states that are measured at nodes 14 (in those cases when the same basis states are used for encoding and measurement).

After sending photon states that directly encode binary information to nodes 14A and 14B, station 10 may communicate to nodes 14A and 14B what pairs of basis states were used to encode each of the binary values sent to that node. If station 10 sent encoded binary values to node 14A that were not all the same as the corresponding binary values sent to node 14B then station 10 may additionally send to nodes 14A and 14B parity information indicating whether the corresponding binary values were the same or different.

For each of the photon states, sent by station 10, nodes 14A and 14B may each select a measurement configuration that configures their respective optical detectors to make measurements of the photon state relative to one of the pairs of basis states. Each node 14 may randomly select a measurement configuration for each photon state. Station 10 may subsequently share with each nodes 14 information as to which bases were used to encode bit values in the photon states send to that node 14. Nodes 14A and 14B may each ignore results of any measurements on photon states for which the measurement configuration specified a measurement relative to a pair of the basis states that was different from the pair of basis states used by station 10 to encode the binary value in the photon state.

Nodes 14A and 14B share information regarding which photon states from station 10 were successfully received by the respective one of nodes 14A and 14B and measured in a basis that matched the basis used by station 10 to encode a bit value in the photon state.

Each of nodes 14A and 14B may prepare a raw key based on the binary values of those corresponding pairs of the photon states where each of nodes 14A and 14B successfully received one of the corresponding pair of photon states and measured the respective photon states in the correct basis together with corresponding parity information from station 10.

Another way to perform QKD using a system as described herein is for one node 14 (e.g. node 14A) to generate quantum states that each encode a value in a selected one of plural bases and to use entanglement between node 14A and another node e.g. node 14B) to teleport the quantum state to node 14B. Node 14B may then measure the quantum state in one of the plural bases. Nodes 14A and 14B may share information regarding which bases were used to encode and measure each of the teleported quantum states. Nodes 14A and 14B may each create a raw key from the values encoded in those quantum states which were encoded and measured in the same basis. As an alternative to teleporting the quantum states from node 14A to 14B using entanglement between quantum systems of nodes 14A and 14B the system may operate station 10 as a quantum repeater to deliver the encoded quantum state from node 14A to node 14B.

### Option of Entanglement Distillation

As described herein, the present technology may be applied to create multiple pairs of entangled quantum systems. For example plural quantum systems of station 10 may be pairwise entangled with plural quantum systems of a node 14. By entanglement swapping, plural quantum systems of one node 14 may be pairwise entangled with plural quantum systems of another node 14.

In some embodiments, entanglement distillation is performed. Entanglement distillation is a process that can be applied to a first number of original entangled states to yield a second, smaller, number of entangled states which have greater fidelity (i.e. are closer to being maximally entangled) than the original entangled states. Entanglement distillation may be performed on a set of entangled states which each include a quantum state of a quantum system of a node 14 and a quantum state of a quantum system of station 10 and/or on a set of entangled states that each include a quantum state of a quantum system of a node 14 and a quantum state of a quantum system of another node 14. For example, entanglement distillation may be performed on a set of entangled states between quantum systems of station 10 and quantum systems of node 14A prior to creating entanglement between one or more quantum systems of station 10 and one or more quantum systems of a second node 14B.

Entanglement distillation may be performed selectively in cases where surplus entangled states are available and/or the benefit of increased fidelity of the entangled states justifies preserving fewer entangled states. For example, entanglement distillation may be initiated upon: a determination that more than a threshold number of quantum systems 15AM are in use storing quantum states that correspond to emitted photon states, and/or fewer than a threshold number of quantum systems 15AM are available to store quantum states corresponding to emitted photon states and optical link 12A is still available. In some embodiments, entanglement distillation is performed to achieve a desired number of entangled pairs of quantum systems for which the entangled states have at least a desired entanglement fidelity.

### Example Variations

While the present technology has been described using the example of a station 10 and two nodes 14A and 14B, the present technology may be embodied in system comprising plural stations and/or more than two nodes. Nodes and stations may, for example, be arranged to provide a quantum-repeater linear chain, a hub-and-spoke model, or a mesh network, combinations of any of these or a network having any other suitable topology.

A station 10, 40 may use optical links 12 to three or more nodes 14, 44 to distribute entanglement to quantum systems 15, 45 of the station 10, 40 and quantum systems of each of the nodes 14, 44. That entanglement may be swapped to generate entanglement between quantum systems 15, 45 of any two of the three or more nodes 14, 44 according to a plan or as-required.

It is not mandatory that photon states are generated at a station 10, 40 and sent from the station to a node 14, 44 via an optical link 12. In some embodiments the photon states are generated at a node (or further station) and sent to a station to generate entanglement between a quantum system of the node and a quantum system of the station. A node may be configured to deliver photon states to a station in the same rapid-fire manner as described elsewhere herein. To facilitate this the node may include communication quantum systems analogous to quantum systems 15AC, 45AC and memory quantum systems analogous to quantum systems 15AM, 45AM as well as a mechanism for swapping quantum states from communication quantum systems to memory quantum systems and a controller operable to appropriately initialize the communication and memory quantum systems, cause the communication quantum systems to sequentially emit photon states into the optical link and transfer quantum states of the communication quantum systems to memory quantum systems after emission of the photon state.

In some embodiments, quantum systems 15AN, 15BN, 45AN, 45BN of a node 14, 44 include communications quantum systems and memory quantum systems.

The communications quantum systems may interact with photon states to generate entanglement. Quantum states of the communication quantum systems may then be transferred to the memory quantum systems. The memory quantum systems may have longer decoherence times than the communication quantum systems.

In some embodiments, an optical link 12 carries photon states as described herein and other optical communication signals simultaneously. The other optical communication signals may be distinguishable from the photon states. For example, the other optical signals may have a polarization state or wavelength band different from that of the photon states. In some embodiments the other optical signals comprise classical optical signals. In some embodiments optical channel 12 is used exclusively for transmitting photon states at least during specified time periods.

It is not necessary that memory quantum systems be segregated (e.g. it is not mandatory that there a set of quantum systems that are used to store quantum states of quantum systems that emit photon states into optical link 12A—e.g. quantum systems 15AM or 45AM—that is distinct from a set of quantum systems that are used to store quantum states of quantum systems that emit photon states into optical link 12B—e.g. quantum systems 15BM or 45BM). A station 10 or 40 may include a pool of memory quantum systems that may be used as quantum memories for a range of purposes. A controller 20 of station 10 or 40 may keep track of what quantum information is stored in which of the quantum systems in the pool, how long that quantum information has been stored, and/or which of the memory quantum systems are available to receive stored quantum information.

It is not necessary that communication quantum systems be segregated (e.g. it is not mandatory that there is a set of communication quantum systems that emit or receive photon states that travel on optical link 12A—e.g. quantum systems 15AC or 45AC—that is distinct from a set of quantum systems that are used to emit or receive photon states that travel on optical link 12B—e.g. quantum systems 15BCor 45BC). A station 10 or 40 may include a pool of communication quantum systems that may be optically coupled by a suitable optical switching network to emit photon states into or to receive photon states from any of a plurality of optical links 12. A controller 20 of station 10 or 40 may control the optical switching network as needed to guide photon states from a particular communication quantum system into a particular optical link and/or to guide photon states received from a node via a particular optical link to a particular BSA or a particular communication quantum system.

In some embodiments distinguishable photon states may be sent simultaneously via the same optical link 12. This approach may be used to increase a number of photon states that can be exchanged between a station 10 and node 14 in a given time. For example, two or more photon states having different wavelengths and/or polarization states may be transmitted simultaneously or at overlapping times. For example, plural quantum systems 15 may be optically coupled to a single cavity or single waveguide and may be caused to emit distinguishable photon states into an optical path essentially simultaneously.

Stations 10 and nodes 14 may be fixed relative to the earth and/or moving. For example, stations 10 and nodes 14 may be carried by orbiting satellites, aircraft, ships, land vehicles, subways, heavy equipment, lighter than air craft, of any kinds and/or may be at fixed locations. The present technology may be employed to particular advantage in any case where windows within which communication of photon states between a station and associated nodes is permitted are limited. Optical paths 12 may be provided by optical fibers or other optical waveguides, and/or free space propagation through optically transmissive media such as air, other gases, vacuum, and/or liquids such as water.

In some embodiments station 10 is configured to perform quantum error correction (or fault tolerant operation) on memory quantum systems (e.g. 15AM, 15BM). This may extend the storage time of the memory quantum systems. Station 10 may incorporate any suitable error correction and/or fault tolerant systems.

As discussed above, in some embodiments, information may be encoded in photon states in a certain basis at a source of the photon states (e.g. a node 14 or a station 10) and the photon states may be measured in a certain basis at a destination of the photon states (e.g. a station 10 or a node 14). As described herein, there are cases where the basis used to encode a photon state must match the basis used to measure the photon state and cases where the bases used to measure two photon states at different locations (e.g. different nodes) must match. Basis states may be orientation dependent. For example, polarization states may be defined relative to X and Y axes. Especially where the source and destinations are located at moving systems (e.g. satellites, vehicles etc.) it may not be known what measurement basis at one location matches a particular measurement basis at another location or a basis in which information may be encoded in a photon state at another location. In some embodiments this issue is addressed by one or more of:
sending, on an optical link, classical optical pilot pulses in the various bases and applying rotation corrections to determine rotations at which the classical pilot pulses are correctly measured at another end of the optical link;
sending quantum signals (e.g. single photons) in which information has been encoded using various bases and applying corrections to reduce the error rate (obtained by comparing the information encoded in the quantum signals to results of the measurements)
using a protocol for encoding information that only needs to be aligned in one direction (e.g. Z=Z) as described for example in Demonstration of a 6 State-4 State Reference Frame Independent channel for Quantum Key Distribution Appl. Phys. Lett. 115, 211103 (2019) https://doi.org/10.1063/1.5125700 also published at arxiv.org [1905.09197].
Other techniques known to those of skill in the art.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

The present invention may be embodied in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

### INTERPRETATION OF TERMS

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for distributing quantum entanglement, the method comprising:
at a station:
when a first optical link between the station and a first node is available, causing a first communication quantum system of the station to emit a first photon state that is entangled with a first quantum state of the first communication quantum system into the first optical link;
when a second optical link between the station and a second node is available, causing a second communication quantum system of the station to emit a second photon state that is entangled with a second quantum state of the second communication quantum system into the second optical link;
receiving first and second information:
the first information indicating that entanglement of the first quantum state with a first node quantum system of the first node was generated using the first photon state; and
the second information indicating that entanglement of the second quantum system with a second node quantum system of the second node was generated using the second photon state; and
causing quantum states of the first node quantum system and the second node quantum system to be entangled by performing a measurement on the first and second quantum states.

2. The method according to claim 1 wherein the first and second communication quantum systems of the station each comprises an electron spin and the first photon state and the second photon state each comprises a spin-entangled photon state.

3. The method according to claim 1 comprising, after emission of the first photon state, transferring the first quantum state of the first communication quantum system to a first memory quantum system of the station, and/or after emission of the second photon state, transferring the second quantum state of the second communication quantum system to a second memory quantum system of the station.

4. (canceled)

5. The method according to claim 3 wherein the first memory quantum system comprises a nuclear spin and/or the second memory quantum system comprises a nuclear spin.

6. The method according to claim 5 wherein:
the station comprises a plurality of T centres,
each of the first and second communication quantum systems comprises an electron spin of one of the plurality of T centres; and
the first memory quantum system comprises a nuclear spin of one of the plurality of T centres and/or the second memory quantum system comprises a nuclear spin of one of the T centres.

7. (canceled)

8. The method according to claim 1 wherein one or more of the station, the first node and the second node is moving relative to the earth.

9. The method according to claim 8 wherein the station is carried by an earth orbiting satellite.

10. The method according to claim 9 wherein the satellite is orbiting in an orbit that is not geostationary.

11. The method according to claim 1 wherein the first and second optical links comprise free space optical links.

12. The method according to claim 1 wherein the first communication quantum system is one of a plurality of first communication quantum systems of the station and the method comprises:
sequentially causing each of the first communication systems to emit a respective first photon state into the first optical link.

13. (canceled)

14. The method according to claim 12 comprising, after each of the first communication quantum systems has been caused to emit the respective photon state, transferring a respective first quantum state of the first communication quantum system to a respective one of a plurality of memory quantum systems of the station.

15. The method according to claim 12 wherein the second communication quantum system is one of a plurality of second communication quantum systems of the station and the method comprises:
sequentially causing each of the second communication systems to emit a respective second photon state into the second optical link.

16. The method according to claim 15 wherein:
the first information indicates, for each of the respective first photon states, whether or not entanglement of the respective first quantum state with a first node quantum system of the first node was generated using the respective photon state; and
the second information indicates, for each of the respective second photon states, whether or not entanglement of the respective second quantum state with a second node quantum system of the second node was generated using the respective second photon state.

17. The method according to claim 16 wherein:
the measurement is one of a plurality of measurements;
the method comprises using the first and second information to identify plural pairs of the quantum systems of the station wherein each of the pairs includes one quantum system of the station that is entangled to a corresponding quantum system of the first node and one quantum system of the station that is entangled with a corresponding quantum system of the second node; and
performing the measurement on the first and second quantum states comprises performing one of the plurality of measurements on each of the plurality of pairs of quantum systems of the station.

18. The method according to claim 1 wherein:
the first communication quantum system is one of a plurality of first communication quantum systems of the station; and
the second quantum system is one of a plurality of second communication quantum systems of the station;
the method comprises emitting a sequence of the first photon states and a sequence of second photon states;
the first information indicates whether or not each of the first photon states in the sequence of first photon states resulted in entanglement of a corresponding one of the first quantum states with a quantum state of corresponding one of a plurality of first node quantum systems of the first node;
the second information indicates whether or not each of the second photon states in the sequence of second photon states resulted in entanglement of a corresponding one of the second quantum states with a quantum state of corresponding one of a plurality of second node quantum systems of the second node; and
the method comprises:
while the first optical link is available, controlling the first communication quantum systems to emit a sequence of first photon states into the first optical link, each of the first photon states being entangled with a respective first quantum state of the respective first communication quantum system that emitted the respective one of the first photon states and, after emitting each of the first photon states transferring the respective first quantum state to a corresponding one of a plurality of first memory quantum systems of the station;
while the second optical link is available, controlling the second communication quantum systems to emit a sequence of second photon states into the first optical link, each of the second photon states being entangled with a respective second quantum state of the respective second communication quantum system that emitted the respective one of the second photon states;
creating plural entangled pairs, each of the plural entangled pairs comprising one of the first node quantum systems and one of the second node quantum systems, by performing Bell state measurements at the station between one of the first quantum states and one of the second quantum states.

19. The method according to claim 1 wherein the first and second optical links are not concurrently available.

20. The method according to claim 1 comprising, monitoring the first optical link to determine when the first optical link is available and causing the first communication quantum system to emit the first photon state into the first optical link in response to determining that the first optical link is available.

21. (canceled)

22. A station operable to distribute quantum entanglement, the station comprising:
a plurality of quantum systems, the plurality of quantum systems comprising:
a plurality of first communication quantum systems operative to emit first photon states into a first optical link, and
a plurality of second communication quantum systems operative to emit second first photon states into a second optical link;
a measurement system comprising at least one Bell state analyzer (BSA), the measurement system operable to perform Bell state measurements (BSMs) between pairs of the quantum systems of the station; and
a controller configured to:
when the first optical link between the station and the first node is available, cause a first one of the communication quantum systems of the station to emit a first photon state that is entangled with a first quantum state of the first one of the communication quantum systems into the first optical link;
when a second optical link between the station and a second node is available cause a second one of the communication quantum systems of the station to emit a second photon state that is entangled with a second quantum state of the second communication quantum system into the second optical link; and
cause quantum states of the first node quantum system and the second node quantum system to be entangled by performing a measurement on the first and second quantum states using the measurement system.

23-43. (canceled)

44. An entanglement distribution system comprising the station according to claim 22 in combination with the first and second nodes.

45. A non-transitory medium carrying a set of computer-readable instructions which, when executed by a processor of a station, cause the station to:
when a first optical link between the station and a first node is available, cause a first communication quantum system of the station to emit a first photon state that is entangled with a first quantum state of the first communication quantum system into the first optical link;
when a second optical link between the station and a second node is available, cause a second communication quantum system of the station to emit a second photon state that is entangled with a second quantum state of the second communication quantum system into the second optical link;
receive first and second information:
the first information indicating that entanglement of the first quantum state with a first node quantum system of the first node was generated using the first photon state; and
the second information indicating that entanglement of the second quantum system with a second node quantum system of the second node was generated using the second photon state; and
cause quantum states of the first node quantum system and the second node quantum system to be entangled by performing a measurement on the first and second quantum states.
